(19) United States
(12) Patent Application Publication
(10) Pub. No.: US 2024/0075423 A1
(43) Pub. Date: Mar. 7, 2024

(54) A PROCESS FOR SEPARATING H2 FROM A GAS MIXTURE

(71) Applicant: BASF SE, Ludwigshafen am Rhein (DE)

(72) Inventors: Paul-Vinzent STROBEL, Ludwigshafen am Rhein (DE); Emiel Jan KAPPERT, Ludwigshafen am Rhein (DE); Kai Rainer EHRHARDT, Ludwigshafen am Rhein (DE); Juergen Jose VARGAS SCHMITZ, Ludwigshafen am Rhein (DE); Martin GALL, Ludwigshafen am Rhein (DE)

(21) Appl. No.: 18/038,229

(22) PCT Filed: Nov. 26, 2021
(86) PCT No.: PCT/EP2021/083156

§ 371 Date: May 23, 2023

(30) Foreign Application Priority Data
Nov. 27, 2020 (EP) 20210241.4

(51) Int. Cl. B01D 53/22; C01B 3/50

(52) U.S. Cl. CPC B01D 53/226; C01B 3/501; B01D 2053/223; B01D 2256/16; B01D 2257/7025; C01B 2203/0405; C01B 2203/048; C01B 2203/061; C01B 2203/062; C01B 2203/068; C01B 2203/147

(57) ABSTRACT

The present invention relates a process for separating H₂, preferably both H₂ and CH₄, from a gas mixture comprising H₂ and CH₄ by means of a series of selective membrane units that avoids compressors and vacuums as well as an apparatus for carrying out said separation.

Hydrogen is a promising energy carrier, but its storage and transportation are difficult. It has been proposed that transportation—and to a more limited extent storage—of “green hydrogen” could be accomplished in the existing natural gas (NG) grid. Extensive information on this subject can be found in the research report by the Deutscher Verein des Gas- and Wasserfaches e.V. (2019) titled “Anforderungen, Möglichkeiten and Grenzen der Abtrennung von Wasserstoff aus Wasser-stoff/Erdgasgemischen”. Consequently and as considered by said report, use of hydrogen transported in large quantities in the existing natural gas network as mixtures with natural gas presents problems for users that require natural gas free of hydrogen or purified hydrogen. Thus the aforementioned 2019 report proposes separation of hydrogen from the natural gas components by means of a gas permeable membrane approach.

The aforementioned 2019 report considers the use of both hydrogen and methane separately from an economic perspective but does not consider the use of the intermediate mixtures thereof as separate distinct end products. Furthermore, a complication not considered in said 2019 report in separating the mixture of hydrogen and natural gas is the expected dynamic concentration of hydrogen and the technology required to handle said changes since the hydrogen content in the natural gas network will vary seasonally. Specifically, it is expected that the hydrogen concentration comprised in the natural gas grid will dynamically change as much as between 0 and 30 mol.-% of the total concentration of components on a seasonal basis. Thus a complication arises in that compressors are designed for a fixed operating point and are not entirely suitable for the expected dynamic operation since the volume of a stream to be compressed will change greatly with the amount of hydrogen contained in the natural gas. Therefore, use of compressors under dynamic hydrogen concentrations are expected to require added expenditure in equipment, maintenance from increased wear, increased energy use and added safety issues due to special equipment required for handling hydrogen. Thus there is a need to avoid or minimize use of compressors under dynamic changes in H₂ concentration when separating H₂ and CH₄ from mixtures. European patent application EP 2979743 A1 addresses the changing concentration of H₂ and CH₄ mixtures by mixing and storing hydrogen with natural gas compressed in subterranean reservoirs which is then provided at a consistent quality. However, this approach requires geological formations that can be adapted as reservoirs to the need and thus also provide an additional environmental requirement that is not easily addressed in all situations. Accordingly, there is a need to provide a method and device that can be adapted to the situation wherein a dynamic concentration of H₂ requires a system that avoids use of compressors.

Even under dynamic hydrogen conditions, intermediate purities of hydrogen that are obtained can be advantageously used in combination with further purifications such as pressure swing adsorption (PSA) and thus by-pass methanation and water gas shift operations for producing purified H₂. Thus additional economic and environmental benefits can be realized by further purification of the obtained intermediate purities of hydrogen. In this instance, if some compressors are required for recompression, the investment may be justified in avoiding the need of steam methane reforming and water gas shift operations, both of which are process steps that cause significant CO₂ emissions during the production of hydrogen. However when purifying intermediate concentrations of hydrogen, if higher pressure intermediate purities can be provided, this would also reduce the number of compressor stages necessary for entry to PSA purification. Thus even if compressors were used for intermediate purities of hydrogen, if the initial purification can provide sufficient pressure and purity, the amount of equipment required can be reduced at a substantial savings. Finally, without the intention of being bound by theory, it is believed that minimizing the number of compressors allows for the system to better handle changing concentration in hydrogen since there will be no need, or minimized need, to vary the workload of compressors to compensate. Therefore, a minimal number of compressors, preferably none, should be placed interactively within the flow path through the inventive device and method of separating hydrogen and natural gas.

Thus there is a need for separation of hydrogen and natural gas on an industrial scale in not only pure hydrogen and methane, but also one or more streams with defined mixtures of hydrogen and methane while maintaining an economically viable and environmentally friendly process.

The present invention relates a process for separating H₂, preferably both H₂ and CH₄, from a gas mixture comprising H₂ and CH₄, the process comprising
(i) a separation stage comprising
   (i.1) passing a feed gas stream F1 comprising H₂ and CH₄ at a molar ratio n(H₂):n(CH₄)=x(F1), 0<x(F1)≤0.5, through a membrane unit A comprising at least one membrane, the at least one membrane having a H₂/CH₄ selectivity of at least 10, at a pressure ratio φ across said at least one membrane, calculated as (pressure of feed gas stream F1/pressure of permeate gas stream P1) at constant temperature, of greater than 1, obtaining
      a permeate gas stream P1 comprising H₂ and CH₄ at a molar ratio n(H₂):n(CH₄)=x(P1); x(P1)>x(F1); and
      a retentate gas stream R1 comprising H₂ and CH₄ at a molar ratio n(H₂):n(CH₄)=x(R1); x(R1)<x(F1);
   (i.2) passing retentate gas stream R1 as a further feed gas stream F2 through a further separation stage, F2 having the same composition as R1;
(ii) a further separation stage comprising
   (ii.1) passing F2 through a membrane unit B comprising at least one membrane, the at least one membrane having a H₂/CH₄ selectivity of at least 10, at a pressure ratio ϕ across said at least one membrane, calculated as (pressure of feed gas stream F2/pressure of permeate gas stream P2) at constant temperature, of greater than 1, obtaining
      a permeate gas stream P2 comprising H₂ and CH₄ at a molar ratio n(H₂):n(CH₄)=x(P2) of at least 1.4; x(P2)>x(F2); and
      a retentate gas stream R2 comprising H₂ and CH₄ at a molar ratio n(H₂):n(CH₄)=x(R2) of <0.17; x(R2)<x(F2);
   (ii.2) optionally passing retentate gas stream R2 as a further feed gas stream F3 through a further separation stage (iii), F3 having the same composition as R2;
(iii) an optional further separation stage comprising
   (iii.1) passing F3 through a further membrane unit C comprising at least one membrane, the at least one membrane having a H₂/CH₄ selectivity of at least 10, at a pressure ratio ϕ across said at least one membrane (calculated as the (pressure of feed gas stream F3/pressure of permeate gas stream P3) at constant temperature), of greater than 1, obtaining
      a permeate gas stream P3 comprising H₂ and CH₄ at a molar ratio n(H₂):n(CH₄)=x(P3) of at least 0.39; x(P3)>x(F3); and
      a retentate gas stream R3 comprising H₂ and CH₄ at a molar ratio n(H₂):n(CH₄)=x(R3) of ≤0.01.

Preferably, no vacuum apparatus or compressor is operated downstream of the membrane unit A; and wherein preferably no vacuum apparatus or compressor is operated downstream of the membrane unit A in the obtainment of the permeate gas streams and/or retentate gas streams, more preferably in the obtainment of permeate gas stream P1 and/or retentate gas R1.

Preferably, the at least one membrane comprised in membrane unit A has a H₂/CH₄ selectivity of at least 10, preferably of at least 50, more preferably of at least 75, more preferably of at least 100, more preferably of at least 150, more preferably of at least 175, more preferably of at least 200.

Preferably, the at least one membrane comprised in membrane unit A has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250, more preferably in the range of from 200 to 250.

Preferably, the at least one membrane comprised in membrane unit A is selected from the group consisting of polymer membranes, inorganic membranes, carbon membranes, metal membranes, proton-conducting ceramic membranes and combinations of two or more thereof including composites or hybrids of two or more thereof.

More preferably the at least one membrane comprised in membrane unit A is preferably selected from the group consisting of polymer membranes, inorganic membranes, carbon membranes, palladium metal membranes, proton-conducting ceramic membranes, and combinations of two or more thereof including composites or hybrids of two or more thereof, more preferably selected from the group consisting of polymer membranes, inorganic membranes, palladium metal membranes and combinations of two or more thereof including composites or hybrids of two or more thereof, more preferably selected from the group consisting of polymer membranes and inorganic membranes and combinations of two or more thereof including composites of two or more thereof. More preferably, the at least one membrane comprised in membrane unit A are polymer membranes, inorganic membranes or hybrids, more preferably being polymer membranes or inorganic membranes.

It can be preferred that the at least one membrane comprised in membrane unit A are metal membranes. In the context of the present invention, any metal membranes can be used as far as they permit to obtain a permeate gas stream P1 and a retentate gas stream R1, it is however preferred that the metal membranes disclosed in the foregoing are preferred. It is more preferred that the at least one membrane comprised in membrane unit A are palladium metal membranes.

Preferably, the at least one membrane comprised in membrane unit A has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit A has a geometry of hollow fiber.

As to metal membranes in relationship to the present invention, metal membranes are defined as membranes comprising, optionally consisting of, one or more metallic element from groups 5, 6, 7, 8, 9, 10 and 11 of the Periodic Table including alloys of two or more elements thereof, preferably metal membranes are defined as membranes comprising, optionally consisting of, Pd, Pt, Nb, Ta, Cu, Ag, Au, Fe, Ru, Y, La, In, Ni and V including alloys from two or more thereof, more preferably comprising, optionally consisting of, Pd, Ni and V, including alloys of two or more thereof, more preferably comprising, optionally consisting of, Pd or V. It is preferred that metal membranes are palladium metal membranes, wherein more preferably palladium metal membranes comprise at least 50 wt.-%, more preferably at least 60 wt.-%, more preferably of at least 70 wt.-% of Pd, based on the total weight of the palladium metal membrane. It is preferred that the palladium metal membranes comprise in the range of from 50 wt.-% to 99.5 wt.-%, more preferably in the range of from 55 wt.-% to 99 wt.-%, more preferably in the range of from 65 wt.-% to 97 wt.-%, more preferably in the range of from 70 wt.-% to 90 wt.-%, more preferably in the range of from 75 wt.-% to 85 wt.-% of Pd, based on the total weight of the palladium metal membrane. It is preferred that palladium metal membranes are alloys, more preferably alloys comprising Pd and one or more of Ag, Au, Ru, In, Cu and Y, more preferably Pd and one or more of Ag, Cu and Y, more preferably Pd and Ag, wherein it is further preferred that the alloyed metals other than palladium are present in an amount, calculated as elemental metal, in the range of from 0.50 wt.-% to 50 wt.-%, more preferably in the range of from 1 wt.-% to 45 wt.-%, more preferably in the range of from 3 wt.-% to 35 wt.-%, more preferably in the range of from 7 wt.-% to 30 wt.-%, more preferably in the range of from 8 wt.-% to 15 wt.-%, based on the total weight of the palladium metal membrane. It is preferred that metal contaminants within the Pd metal membrane are present in at most 3 wt.-%, more preferably at most 1.5 wt.-%, more preferably at most 1 wt.-%, more preferably at most 0.5 wt.-%, more preferably at most 0.1 wt.-%, based on the total weight of the membrane, wherein more preferably the Pd metal membrane is free of metal contaminants within the limits of detection by X-ray fluorescence.

In the context of the present invention, it is further preferred that when metal membranes are present, more preferably palladium metal membranes, said metal membranes operate by a solution-diffusion mechanism. Without the intention of being bound by theory, it is well known in the art that solution-diffusion mechanisms of metal membranes could achieve infinite H₂/CH₄ selectivity under ideal circumstances, since species other than H₂ don't dissolve. However, in practice defects limit the observed selectivity of metal membrane. Therefore, it is possible that with the appropriate choice of a metal membrane, the observed H₂/CH₄ selectivity may be such that the at least one membrane comprised in membrane unit A, B, and/or C, is greater than 2500, preferably greater than 4500, more preferably greater than 5000, more preferably greater than 10000, more preferably in the range of from 2500 to 60,000, more preferably in the range of from 4500 to 20,000, more preferably in the range of from 5000 to 15,000, more preferably in the range of from 6000 to 10,000.

In the context of the present invention, polymeric membranes, inorganic membranes and hybrid membranes as well as composite membranes are preferred to operate by the size-exclusion effect, for inorganic membranes and hybrid membranes often referred to as “molecular sieving”.

Furthermore, in the context of the present invention, it is preferred that the one or more polymer membranes are defined as glassy polymeric membranes, and are more preferably selected from the group of polymeric membranes consisting of polysulfones, polyimides and poly(ether imide)s including combinations of two or more polymers thereof. In the context of the present invention, the term “glassy” is used to refer to a material which is not crystalline.

With regards to inorganic membranes, in the context of the present invention, it is preferred that said membranes are amorphous microporous membranes and/or zeolitic membranes.

With regards to hybrids, also called “hybrid membranes”, in the context of the present invention it is preferred that said hybrids are metal organic frameworks (MOFs) based membranes, more preferably organo-silica based MOFs.

Preferably, the at least one membrane comprised in membrane unit A has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).

Preferably, according to (i.1) the pressure ratio ϕ across the at least one membrane comprised in membrane unit A, calculated as (pressure of feed gas stream F1/pressure of permeate gas stream P1) at constant temperature, is of at least 4, preferably of at least 7 and/or preferably of at most 15, preferably of at most 12.

Preferably, according to (i.1) the pressure ratio ϕ across the at least one membrane comprised in membrane unit A, calculated as (pressure of feed gas stream F1/pressure of permeate gas stream P1) at constant temperature, is in the range of from 1.5 to 25, more preferably in the range of from 2 to 20, more preferably in the range of from 2.5 to 16, more preferably in the range of from 3 to 15, more preferably in the range of from 3.5 to 14, more preferably in the range of from 4 to 13, more preferably in the range of from 4.5 to 12.

Preferably, the mole ratio x(F1) is in the range of from 0.05 to 0.5, preferably in the range of from 0.1 to 0.4, more preferably in the range of from 0.15 to 0.4, more preferably in the range of from 0.2 to 0.3. It is further preferred that when the mole ratio x(F1) is in the range of from 0.05 to 0.5, preferably in the range of from 0.1 to 0.4, more preferably in the range of from 0.15 to 0.4, more preferably in the range of from 0.2 to 0.3, that feed gas stream F1 also has pressure in the range of from 5 to 100 bar (abs), preferably in the range of from 30 to 80 bar (abs), more preferably in the range of from 40 to 75 bar (abs), more preferably in the range of from 50 to 70 bar (abs).

It is preferred that the feed gas stream F1 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the feed gas stream F1 has a temperature in the range of from −30° C. to 60° C. , preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit A is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the feed gas stream F1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When at least one membrane comprised in membrane unit A are inorganic membranes or hybrid membranes, it can be preferred that the feed gas stream F1 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit A are metal membranes, preferably palladium metal membranes, it can be preferred that the feed gas stream F1 has a temperature in the range of from 300° C. to 500° C., more preferably in the range of from 325° C. to 450° C., more preferably in the range of from 350° C. to 400° C.

Preferably, feed gas stream F1 has pressure in the range of from 5 to 100 bar (abs), preferably in the range of from 30 to 80 bar (abs), more preferably in the range of from 40 to 75 bar (abs), more preferably in the range of from 50 to 70 bar (abs).

Preferably, according to (i.1) feed gas stream F1 has a mole ratio of the sum of H₂ and CH₄ to the total amount of all other components present in F1 in the range of from 5 to 99.99, wherein preferably feed gas stream F1 further has a mole ratio of hydrocarbons having 3 carbon atoms or less to the total amount of all other components present in F1 in the range of from 0 to 0.11, wherein preferably feed gas stream F1 further has a mole ratio of CO₂ to the total amount of all other components present in F1 in the range of from 0 to 0.04, wherein preferably feed gas stream F1 further has a mole ratio of trace gases to the total amount of all other components present in F1 in the range of from 0 to 0.01.

Preferably, according to (i.1) feed gas stream F1 has a dynamic H₂ concentration, wherein preferably a dynamic H₂ concentration has a rate of change calculated as the molar ratio of H₂ to CH₄ per day in the range of from 0.000549 to 0.00549, preferably in the range of from 0.0011 to 0.0044, more preferably in the range of from 0.0016 to 0.0044, more preferably in the range of from 0.00219 to 0.00329; wherein preferably all values of mole ratio, pressure, pressure ratio, flow ratio and temperature refer to mean values calculated from the total sum of the respective individual values obtained over a 91 day season.

Preferably, a source of feed gas stream F1 comprises, preferably consists of, CH₄ from natural gas and H₂ from one or more of water electrolysis, steam reformation, partial oxidation, radiolysis, biomass reformation, coal gasification, biomass gasification, fermentation, electrohydrogenesis, thermolysis, and photocatalytic water splitting, wherein preferably the source of feed gas stream F1 comprises, preferably consists of, CH₄ from natural gas and H₂ from one or more of water electrolysis, radiolysis, biomass reformation, biomass gasification, fermentation, electrohydrogenesis, thermolysis and photocatalytic water splitting, wherein more preferably the source of feed gas stream F1 comprises, preferably consists of, CH₄ from natural gas and H₂ from one or more of water electrolysis, biomass reformation, biomass gasification, fermentation, electrohydrogenesis, thermolysis and photocatalytic water splitting.

Preferably, the mole ratio x(P1) is of at least 2, preferably of at least 3, more preferably of at least 5, more preferably of at least 9, preferably of at least 14, more preferably of at least 19. It is further preferred that when the mole ratio x(P1) is of at least 2, preferably of at least 3, more preferably of at least 5, more preferably of at least 9, preferably of at least 14, more preferably of at least 19; and/or the mole ratio x(P1) is in the range of from 2 to 2000, preferably in the range of from 3 to 1000, more preferably in the range of from 4 to 800, more preferably in the range of from 5 to 600, more preferably in the range of from 7 to 500, more preferably in the range of from 9 to 450, more preferably in the range of from 14 to 350, more preferably in the range of from 19 to 300; that the permeate gas stream P1 also has a pressure in the range of from >1 to 50 bar(abs), preferably in the range of from >1.2 to 40 bar(abs), more preferably in the range of from 1.3 to 25 bar(abs), more preferably in the range of from 1.5 to 20 bar(abs), more preferably in the range of from 1.6 to 15 bar(abs), more preferably in the range of from 1.8 to 12 bar(abs), more preferably in the range of from 2 to 8 bar(abs).

Preferably, the mole ratio x(P1) is in the range of from 2 to 2000, preferably in the range of from 3 to 1000, more preferably in the range of from 4 to 800, more preferably in the range of from 5 to 600, more preferably in the range of from 7 to 500, more preferably in the range of from 9 to 450, more preferably in the range of from 14 to 350, more preferably in the range of from 19 to 300.

It is preferred that the permeate gas stream P1 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the permeate gas stream P1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit A is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the permeate gas stream P1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit A are inorganic membranes or hybrid membranes, it can be preferred that the permeate gas stream P1 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit A are metal membranes, preferably palladium metal membranes, it can be preferred that the permeate gas stream P1 has a temperature in the range of from 300° C. to 500° C., more preferably in the range of from 325° C. to 450° C., more preferably in the range of from 350° C. to 400° C.

Preferably, the permeate gas stream P1 has a pressure in the range of from >1 to 50 bar(abs), preferably in the range of from >1.2 to 40 bar(abs), more preferably in the range of from 1.3 to 25 bar(abs), more preferably in the range of from 1.5 to 20 bar(abs), more preferably in the range of from 1.6 to 15 bar(abs), more preferably in the range of from 1.8 to 12 bar(abs), more preferably in the range of from 2 to 8 bar(abs).

Preferably, according to (i.1) the flow rate ratio of feed gas F1 to the permeate gas stream P1 calculated as (flow rate F1/flow rate P1) is in the range of from 2 to 250, more preferably in the range of from 5 to 220, more preferably in the range of from 10 to 210, more preferably in the range of from 15 to 205, more preferably in the range of from 20 to 200.

Preferably, the mole ratio x(R1) is of at most 0.49, preferably of at most 0.39, preferably of at most 0.29, more preferably of at most 0.28. It is further preferred that when , the mole ratio x(R1) is of at most 0.49, preferably of at most 0.39, preferably of at most 0.29, more preferably of at most 0.28; and/or the mole ratio x(R1) is in the range of from 0.045 to 0.49, more preferably in the range of from 0.095 to 0.39, more preferably in the range of from 0.13 to 0.29, more preferably in the range of from 0.145 to 0.28, more preferably in the range of from 0.15 to 0.26; that the retentate gas stream R1 also has a pressure in the range of from 29.5 to 75.5 bar (abs), preferably in the range of from 39.5 to 74.5 bar (abs), more preferably in the range of from 45.5 to 69.5 bar (abs); and preferably that according to (i.1) the flow rate ratio of feed gas F1 to the retentate gas stream R1 calculated as (flow rate F1/flow rate R1) is in the range of from >1 to 2, preferably in the range of from 1.005 to 1.9, more preferably in the range of from 1.05 to 1.8.

Preferably, the mole ratio x(R1) is in the range of from 0.045 to 0.49, more preferably in the range of from 0.095 to 0.39, more preferably in the range of from 0.13 to 0.29, more preferably in the range of from 0.145 to 0.28, more preferably in the range of from 0.15 to 0.26.

It is preferred that the retentate gas stream R1 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the retentate gas stream R1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit A is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the retentate gas stream R1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit A are inorganic membranes or hybrid membranes, it can be preferred that the retentate gas stream R1 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit A are metal membranes, preferably palladium metal membranes, it can be preferred that the retentate gas stream R1 has a temperature in the range of from 300° C. to 500° C., more preferably in the range of from 325° C. to 450° C., more preferably in the range of from 350° C. to 400° C.

Preferably, the retentate gas stream R1 has a pressure in the range of from 29.5 to 75.5 bar (abs), preferably in the range of from 39.5 to 74.5 bar (abs), more preferably in the range of from 45.5 to 69.5 bar (abs).

Preferably, according to (i.1) the flow rate ratio of feed gas F1 to the retentate gas stream R1 calculated as (flow rate F1/flow rate R1) is in the range of from >1 to 2, preferably in the range of from 1.005 to 1.9, more preferably in the range of from 1.05 to 1.8.

Preferably, the process further comprises

(i.2) passing a portion, preferably all, of retentate gas stream R1 as a further feed gas stream F2 through a further separation stage, F2 having the same composition as R1.

Preferably, the process further comprises

(i.2) dividing retentate gas stream R1 in gas stream S1 and a further feed gas stream F2, S1 and F2 having the same composition as R1.

It is further preferred that a portion of gas stream S1, preferably all of gas stream S1, is passed back to the source of feed gas F1, preferably by means of one or more compressors, wherein preferably the pressure of gas stream S1 is greater than the pressure of feed gas F1 after compression.

Preferably, from 0 to 99 wt.-%, preferably from 5 to 75 wt.-%, more preferably from 10 to 50 wt.-%, more preferably from 15 to 25 wt.-%, of the total amount of retentate gas stream R1 is divided into gas stream S1 and the remainder amount of retentate gas stream R1 into further feed gas F2, calculated as (weight of S1/weight of R1).

It is preferred that the gas stream S1 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the gas stream S1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit A is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the gas stream S1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit A are inorganic membranes or hybrid membranes, it can be preferred that the gas stream S1 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit A are metal membranes, preferably palladium metal membranes, it can be preferred that the gas stream S1 has a temperature in the range of from 300° C. to 500° C., more preferably in the range of from 325° C. to 450° C., more preferably in the range of from 350° C. to 400° C.

Preferably, gas stream S1 has a pressure in the range of from 29.5 to 75.5 bar (abs), preferably in the range of from 39.5 to 74.5 bar (abs), more preferably in the range of from 45.5 to 69.5 bar (abs).

Preferably, according to (ii.1), no compressor and/or vacuum apparatus operates between membrane unit A and membrane unit B and preferably no vacuum apparatus operates in the obtainment of permeate gas P2 and/or retentate gas R2.

Preferably, the at least one membrane comprised in membrane unit B has a H₂/CH₄ selectivity of at least 10, preferably of at least 50, more preferably of at least 75, more preferably of at least 100, more preferably of at least 150, more preferably of at least 175, more preferably of at least 200. It is further preferred that the one or more membrane comprised in membrane unit B is identical to the one or more membrane comprised in membrane unit A and/or comprised in membrane unit C.

Preferably, the at least one membrane comprised in membrane unit B has a H₂/CI - 1 4 selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250.

Preferably, the at least one membrane comprised in membrane unit B is selected from the group consisting of polymer membranes, inorganic membranes, carbon membranes, metal membranes, proton-conducting ceramic membranes and combinations of two or more thereof including composites or hybrids of two or more thereof. More preferably, the at least one membrane comprised in membrane unit B are polymer membranes, inorganic membranes or hybrids, more preferably being polymer membranes or inorganic membranes.

It can be preferred the at least one membrane comprised in membrane unit B are metal membranes. In the context of the present invention, any metal membranes can be used as far as they permit to obtain a permeate gas stream P2 and a retentate gas stream R2, it is however preferred that the metal membranes disclosed in the foregoing are preferred. It is more preferred that the at least one membrane comprised in membrane unit B are palladium metal membranes.

More preferably the at least one membrane comprised in membrane unit B is preferably selected from the group consisting of polymer membranes, inorganic membranes, carbon membranes, palladium metal membranes, proton-conducting ceramic membranes, and combinations of two or more thereof including composites or hybrids of two or more thereof, more preferably selected from the group consisting of polymer membranes, inorganic membranes, palladium metal membranes and combinations of two or more thereof including composites or hybrids of two or more thereof, more preferably selected from the group consisting of polymer membranes and inorganic membranes and combinations of two or more thereof including composites of two or more thereof.

Preferably the at least one membrane comprised in membrane unit B has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit B has a geometry of hollow fiber.

Preferably, the at least one membrane comprised in membrane unit B has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).

Preferably, according to (in) the pressure ratio ϕ across the at least one membrane comprised in membrane unit B, calculated as (pressure of feed gas stream F2/pressure of permeate gas stream P2) at constant temperature, is of at least 4, preferably of at least 7 and/or preferably of at most 50, preferably of at most 40.

Preferably, according to (ii.1) the pressure ratio ϕ across the at least one membrane comprised in membrane unit B, calculated as (pressure of feed gas stream F2/pressure of permeate gas stream P2) at constant temperature, is in the range of from 1.5 to 50, more preferably in the range of from 2 to 20, more preferably in the range of from 2.5 to16, more preferably in the range of from 3 to 15, more preferably in the range of from 3.5 to 14, more preferably in the range of from 4 to 13, more preferably in the range of from 4.5 to 12.

Preferably, the mole ratio x(F2) is of at most 0.49, preferably of at most 0.39, preferably of at most 0.29, more preferably of at most 0.28. It is preferred that when the mole ratio x(F2) is of at most 0.49, preferably of at most 0.39, preferably of at most 0.29, more preferably of at most 0.28; and/or the mole ratio x(F2) is in the range of from 0.045 to 0.49, more preferably in the range of from 0.095 to 0.39, more preferably in the range of from 0.13 to 0.29, more preferably in the range of from 0.145 to 0.28, more preferably in the range of from 0.15 to 0.26; that feed gas stream F2 also has a pressure in the range of from 4.5 to 99.5 bar (abs), preferably in the range of from 29.5 to 75.5 bar (abs), more preferably in the range of from 39.5 to 74.5 bar (abs), more preferably in the range of from 45.5 to 69.5 bar (abs).

Preferably, the mole ratio x(F2) is in the range of from 0.045 to 0.49, more preferably in the range of from 0.095 to 0.39, more preferably in the range of from 0.13 to 0.29, more preferably in the range of from 0.145 to 0.28, more preferably in the range of from 0.15 to 0.26.

It is preferred that the feed gas stream F2 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the feed gas stream F2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit B is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the feed gas stream F2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit B are inorganic membranes or hybrid membranes, it can be preferred that the feed gas stream F2 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit B are metal membranes, preferably palladium metal membranes, it can be preferred that the feed gas stream F2 has a temperature in the range of from 300° C. to 500° C., more preferably in the range of from 325° C. to 450° C., more preferably in the range of from 350° C. to 400° C.

Preferably, feed gas stream F2 has a pressure in the range of from 4.5 to 99.5 bar (abs), preferably in the range of from 29.5 to 75.5 bar (abs), more preferably in the range of from 39.5 to 74.5 bar (abs), more preferably in the range of from 45.5 to 69.5 bar (abs).

Preferably, the mole ratio x(P2) is of at least 1.5, preferably of at least 2.3, more preferably of at least 4, more preferably of at least 9. It is preferred that when the mole ratio x(P2) is of at least 1.5, preferably of at least 2.3, more preferably of at least 4, more preferably of at least 9; and/or the mole ratio x(P2) is in the range of from 1.5 to 1000, preferably in the range of from 2.3 to 100, more preferably in the range of from 4 to 50, more preferably in the range of from 5.6 to 20; that the permeate gas stream P2 also has a pressure in the range of from >1 to 15 bar(abs), preferably in the range of from 1.2 to 14 bar(abs), more preferably in the range of from 1.3 to 13 bar(abs), more preferably in the range of from 3 to 11 bar(abs), more preferably in the range of from 4 to 8 bar(abs).

Preferably, the mole ratio x(P2) is in the range of from 1.5 to 1000, preferably in the range of from 2.3 to 100, more preferably in the range of from 4 to 50, more preferably in the range of from 5.6 to 20.

It is preferred that the permeate gas stream P2 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the permeate gas stream P2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit B is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the permeate gas stream P2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit B are inorganic membranes or hybrid membranes, it can be preferred that the permeate gas stream P2 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit B are metal membranes, preferably palladium metal membranes, it can be preferred that the permeate gas stream P2 has a temperature in the range of from 300° C. to 500° C., more preferably in the range of from 325° C. to 450° C., more preferably in the range of from 350° C. to 400° C.

Preferably, the permeate gas stream P2 has a pressure in the range of from >1 to 15 bar(abs), preferably in the range of from 1.2 to 14 bar(abs), more preferably in the range of from 1.3 to 13 bar(abs), more preferably in the range of from 3 to 11 bar(abs), more preferably in the range of from 4 to 8 bar(abs).

Preferably, according to (ii.1) the flow rate ratio of feed gas F2 to the permeate gas stream P2 calculated as (flow rate F2/flow rate P2) is in the range of from 2 to 20 preferably in the range of from 3 to 15, more preferably in the range of from 4 to 11.

Preferably, the mole ratio x(R2) is of at most 0.15, preferably of at most 0.13, more preferably of at most 0.12. It is preferred that when the mole ratio x(R2) is of at most 0.15, preferably of at most 0.13, more preferably of at most 0.12; and/or the mole ratio x(R2) is in the range of from 0.01 to 0.15, more preferably in the range of from 0.015 to 0.14, more preferably in the range of from 0.02 to 0.12; that the retentate gas stream R2 has a pressure in the range of from 29 to 75 bar (abs), preferably in the range of from 39 to 74 bar (abs), more preferably in the range of from 45 to 69 bar (abs); and preferably, according to (ii.1) the flow rate ratio of feed gas F2 to the retentate gas stream R2 calculated as (flow rate F2/flow rate R2) is in the range of from 1.05 to 2, preferably in the range of from 1.07 to 1.7, more preferably in the range of from 1.1 to 1.6.

Preferably, the mole ratio x(R2) is in the range of from 0.01 to 0.15, more preferably in the range of from 0.015 to 0.14, more preferably in the range of from 0.02 to 0.12.

It is preferred that the retentate gas stream R2 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the retentate gas stream R2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit B is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the retentate gas stream R2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit B are inorganic membranes or hybrid membranes, it can be preferred that the retentate gas stream R2 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit B are metal membranes, preferably palladium metal membranes, it can be preferred that the retentate gas stream R2 has a temperature in the range of from 300° C. to 500° C., more preferably in the range of from 325° C. to 450° C., more preferably in the range of from 350° C. to 400° C.

Preferably, the retentate gas stream R2 has a pressure in the range of from 29 to 75 bar (abs), preferably in the range of from 39 to 74 bar (abs), more preferably in the range of from 45 to 69 bar (abs).

Preferably, according to (ii.1) the flow rate ratio of feed gas F2 to the retentate gas stream R2 calculated as (flow rate F2/flow rate R2) is in the range of from 1.05 to 2, preferably in the range of from 1.07 to 1.7, more preferably in the range of from 1.1 to 1.6.

Preferably, the process further comprises

(ii.2) passing a portion, preferably all, of retentate gas stream R2 as a further feed gas stream F3 through a further separation stage, F3 having the same composition as R2.

Preferably, the process further optionally comprises

(ii.2) dividing retentate gas stream R2 in gas stream S2 and a further feed gas stream F2, S2 and F2 having the same composition as R2.

Preferably, from 0 to 99 wt.-%, preferably from 5 to 75 wt.-%, more preferably from 10 to 50 wt.-%, more preferably from 15 to 25 wt.-%, of the total amount of retentate gas stream R2 is divided into gas stream S2 and the remainder amount of retentate gas stream R2 into further feed gas F2, calculated as (weight of S2/weight of R2).

It is preferred that the gas stream S2 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, gas stream S2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit B is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the gas stream S2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit B are inorganic membranes or hybrid membranes, it can be preferred that the gas stream S2 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit B are metal membranes, preferably palladium metal membranes, it can be preferred that the gas stream S2 has a temperature in the range of from 300° C. to 500° C., more preferably in the range of from 325° C. to 450° C., more preferably in the range of from 350° C. to 400° C.

Preferably, gas stream S2 has a pressure in the range of from 29 to 75 bar (abs), preferably in the range of from 39 to 74 bar (abs), more preferably in the range of from 45 to 69 bar (abs).

Preferably, according to (iii.1), no compressor and/or vacuum apparatus operates between membrane unit B and membrane unit C; and wherein preferably no vacuum apparatus operates in the obtainment of permeate gas P3 and/or retentate gas R3.

Preferably, the at least one membrane comprised in membrane unit C has a H₂/CH₄ selectivity of at least 10, preferably of at least 50, more preferably of at least 75, more preferably of at least 100, more preferably of at least 150, more preferably of at least 175, more preferably of at least 200. It is further preferred that the one or more membrane comprised in membrane unit C is identical to the one or more membrane comprised in membrane unit A and/or comprised in membrane unit B.

Preferably, the at least one membrane comprised in membrane unit C has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250.

Preferably, the at least one membrane comprised in membrane unit C is selected from the group consisting of polymer membranes, inorganic membranes, carbon membranes, metal membranes, proton-conducting ceramic membranes and combinations of two or more thereof including composites or hybrids of two or more thereof.

More preferably the at least one membrane comprised in membrane unit C is preferably selected from the group consisting of polymer membranes, inorganic membranes, carbon membranes, palladium metal membranes, proton-conducting ceramic membranes, and combinations of two or more thereof including composites or hybrids of two or more thereof, more preferably selected from the group consisting of polymer membranes, inorganic membranes, palladium metal membranes and combinations of two or more thereof including composites or hybrids of two or more thereof, more preferably selected from the group consisting of polymer membranes and inorganic membranes and combinations of two or more thereof including composites of two or more thereof. More preferably, the at least one membrane comprised in membrane unit C are polymer membranes, inorganic membranes or hybrids, more preferably being polymer membranes or inorganic membranes.

It can be preferred the at least one membrane comprised in membrane unit C are metal membranes. In the context of the present invention, any metal membranes can be used as far as they permit to obtain a permeate gas stream P3 and a retentate gas stream R3, it is however preferred that the metal membranes disclosed in the foregoing are preferred. It is more preferred that the at least one membrane comprised in membrane unit C are palladium metal membranes.

Preferably the at least one membrane comprised in membrane unit C has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit C has a geometry of hollow fiber.

Preferably, the at least one membrane comprised in membrane unit C has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).

Preferably, according to (iii.1) the pressure ratio ϕ across the at least one membrane comprised in membrane unit C, calculated as (pressure of feed gas stream F3/pressure of permeate gas stream P3) at constant temperature is of at least 20, preferably of at least 30, more preferably of at least 33, and/or preferably of at most 50, more preferably of at most 45, preferably of at most 42.

Preferably, according to (iii.1) the pressure ratio ϕ across the at least one membrane comprised in membrane unit C, calculated as (pressure of feed gas stream F3/pressure of permeate gas stream P3) at constant temperature, is in the range of from 20 to 50, more preferably in the range of from 30 to 45, more preferably in the range of from 33 to 42.

Preferably, the mole ratio x(F3) is of at most 0.15, preferably of at most 0.13, more preferably of at most 0.12. It is preferred that when the mole ratio x(F3) is of at most 0.15, preferably of at most 0.13, more preferably of at most 0.12; and/or the mole ratio x(F3) is in the range of from 0.01 to 0.15, more preferably in the range of from 0.015 to 0.14, more preferably in the range of from 0.02 to 0.12; that feed gas stream F3 also has a pressure in the range of from 4 to 99 bar (abs), preferably in the range of from 29 to 75 bar (abs), more preferably in the range of from 39 to 74 bar (abs), more preferably in the range of from 45 to 69 bar (abs).

Preferably, the mole ratio x(F3) is in the range of from 0.01 to 0.15, more preferably in the range of from 0.015 to 0.14, more preferably in the range of from 0.02 to 0.12.

30

It is preferred that the feed gas stream F3 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the feed gas stream F3 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit C is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the feed gas stream F3 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit C are inorganic membranes or hybrid membranes, it can be preferred that the feed gas stream F3 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit C are metal membranes, preferably palladium metal membranes, it can be preferred that the feed gas stream F3 has a temperature in the range of from 300° C. to 500° C., more preferably in the range of from 325° C. to 450° C., more preferably in the range of from 350° C. to 400° C.

Preferably, feed gas stream F3 has a pressure in the range of from 4 to 99 bar (abs), preferably in the range of from 29 to 75 bar (abs), more preferably in the range of from 39 to 74 bar (abs), more preferably in the range of from 45 to 69 bar (abs).

Preferably, the mole ratio x(P3 ) is of at least 0.4, preferably of at least 0.7, more preferably of at least 0.8, more preferably of at least 1.8. It is preferred when the mole ratio x(P3) is of at least 0.4, preferably of at least 0.7, more preferably of at least 0.8, more preferably of at least 1.8; and/or the mole ratio x(P3) is in the range of from 0.4 to 9, preferably in the range of from 0.7 to 5, more preferably in the range of from 0.8 to 4.9, more preferably in the range of from 1.8 to 4.5; that, the permeate gas stream P3 also has a pressure in the range of from >1 to 5 bar(abs), preferably in the range of from 1.1 to 4 bar(abs), more preferably in the range of from 1.2 to 3 bar(abs).

Preferably, the mole ratio x(P3) is in the range of from 0.4 to 9, preferably in the range of from 0.7 to 5, more preferably in the range of from 0.8 to 4.9, more preferably in the range of from 1.8 to 4.5.

It is preferred that the permeate gas stream P3 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the permeate gas stream P3 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit C is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the permeate gas stream P3 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit C are inorganic membranes or hybrid membranes, it can be preferred that the permeate gas stream P3 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit C are metal membranes, preferably palladium metal membranes, it can be preferred that the permeate gas stream P3 has a temperature in the range of from 300° C. to 500° C., more preferably in the range of from 325° C. to 450° C., more preferably in the range of from 350° C. to 400° C.

Preferably, the permeate gas stream P3 has a pressure in the range of from >1 to 5 bar(abs), preferably in the range of from 1.1 to 4 bar(abs), more preferably in the range of from 1.2 to 3 bar(abs).

Preferably, according to (iii.1) the flow rate ratio of feed gas F3 to the permeate gas stream P3 calculated as (flow rate F3/flow rate P3) is in the range of from 2.5 to 42 preferably in the range of from 5 to 35, more preferably in the range of from 10 to 20.

Preferably, the mole ratio x(R3) is of at most 0.009, preferably of at most 0.005, more preferably of at most 0.002. It is preferred when the mole ratio x(R3) is of at most 0.009, preferably of at most 0.005, more preferably of at most 0.002; and/or the mole ratio x(R3) is in the range of from 0.01 to 0.005, more preferably in the range of from 0.009 to 0.004, more preferably in the range of from 0.008 to 0.002; that the retentate gas stream R3 has a pressure in the range of from 28.5 to 74.5 bar (abs), preferably in the range of from 38.5 to 73.5 bar (abs), more preferably in the range of from 44.5 to 68.5 bar (abs); and preferably also that according to (iii.1) the flow rate ratio of feed gas F3 to the retentate gas stream R3 calculated as (flow rate F3/flow rate R3) is in the range of from 1.01 to 1.6, preferably in the range of from 1.05 to 1.4, more preferably in the range of from 1.09 to 1.3.

Preferably, the mole ratio x(R3) is in the range of from 0.01 to 0.005, more preferably in the range of from 0.009 to 0.004, more preferably in the range of from 0.008 to 0.002.

It is preferred that the retentate gas stream R3 has a temperature in the range of from −30° C. to 500° C., preferably in the range of from −15° C. to 450° C., more preferably in the range of from 0° C. to 400° C., more preferably in the range of from 0° C. to 300° C., more preferably in the range of from 5° C. to 200° C., more preferably in the range of from 15° C. to 190° C.

Preferably, the retentate gas stream R3 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

It is preferred that when the at least one membrane comprised in membrane unit C is selected from the group consisting of polymer membranes, inorganic membranes, carbon membranes, metal membranes, proton-conducting ceramic membranes and combinations of two or more thereof including composites or hybrids of two or more thereof, more preferably selected from the group consisting of polymer membranes, inorganic membranes and hybrids including combinations of two or more thereof, more preferably being polymer membranes, inorganic membranes or hybrids, more preferably being polymer membranes or inorganic membranes, the retentate gas stream R3 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.

When the at least one membrane comprised in membrane unit C are inorganic membranes or hybrid membranes, it can be preferred that the retentate gas stream R3 has a temperature in the range of from 60° C. to 300° C., more preferably in the range of from 70° C. to 200° C., more preferably in the range of from 80° C. to 190° C., more preferably in the range of from 100° C. to 190° C.

When the at least one membrane comprised in membrane unit C are metal membranes, preferably palladium metal membranes, it can be preferred that the retentate gas stream R3 has a temperature in the range of from 300° C. to 500° C., more preferably in the range of from 325° C. to 450° C., more preferably in the range of from 350° C. to 400° C.

Preferably, the retentate gas stream R3 has a pressure in the range of from 28.5 to 74.5 bar (abs), preferably in the range of from 38.5 to 73.5 bar (abs), more preferably in the range of from 44.5 to 68.5 bar (abs).

Preferably, according to (iii.1) the flow rate ratio of feed gas F3 to the retentate gas stream R3 calculated as (flow rate F3/flow rate R3) is in the range of from 1.01 to 1.6, preferably in the range of from 1.05 to 1.4, more preferably in the range of from 1.09 to 1.3.

Preferably, the preceding process further comprising
purifying one or more of the permeate gas stream P2 and the permeate stream P3.

The present invention further relates an apparatus for separating H₂, preferably both H₂ and CH₄, from a gas mixture comprising H₂ and CH₄, the apparatus comprising
(I) a unit comprising
   (I.a) a feeding means for passing a feed gas stream F1 comprising H₂ and CH₄ to a membrane unit A;
   (I.b) the membrane unit A connected to the feeding means for passing a feed gas stream F1 according to (I.a), said membrane unit comprising at least one membrane, the at least one membrane having a H₂/CH₄ selectivity of at least 10;
   (I.c) an exiting means connected to the membrane unit A, for removing a permeate gas stream P1 from the membrane unit A;
   (I.d) an exiting means connected to the membrane unit A for removing a retentate gas stream R1 from the membrane unit A;
(II) a unit comprising
   (II.a) a feeding means, connected to the exiting means according to (I.d), for passing the gas stream R1 as a feed gas F2 to a membrane unit B;
   (II.b) the membrane unit B connected to the feeding means for passing a feed gas stream F2 according to (II.a), said membrane unit comprising at least one membrane, the at least one membrane having a H₂/CH₄ selectivity of at least 10;
   (II.c) an exiting means connected to the membrane unit B for removing a permeate stream P2 from the membrane unit B;
   (II.d) an exiting means connected to the membrane unit B for removing a retentate stream R2 from the membrane unit B;
(III) optionally a unit comprising
   (III.a) a feeding means, connected to the exiting means according to (II.d), said feeding means for passing the gas stream F3 to a membrane unit C;
   (III.b)the membrane unit C connected to the feeding means according to (III.a), said membrane unit comprising at least one membrane, the at least one membrane having a H₂/CH₄ selectivity of at least 10;
   (III.c) an exiting means connected to the membrane unit C for removing a permeate stream P3 from the membrane unit C;
   (III.d) an exiting means connected to the membrane unit C for removing a retentate stream R3 from the membrane unit C.

Preferably, said apparatus is for separating H₂, preferably both H₂ and CH₄, according to the preceding inventive process.

Preferably, in unit (I), there is no compressor upstream of the membrane unit A.

Preferably, the apparatus has an inlet end and an outlet end, wherein the unit (I) has an inlet end and an outlet end, wherein the unit (I) is the first unit of the apparatus and wherein no compressor is located between the inlet end of the apparatus and the inlet end of the unit (I).

Preferably, the at least one membrane comprised in the membrane unit A is selected from the group consisting of polymer membranes, inorganic membranes, carbon membranes, metal membranes, proton-conducting ceramic membranes and combinations of two or more thereof including composites or hybrids of two or more thereof.

More preferably the at least one membrane comprised in membrane unit A is preferably selected from the group consisting of polymer membranes, inorganic membranes, carbon membranes, palladium metal membranes, proton-conducting ceramic membranes, and combinations of two or more thereof including composites or hybrids of two or more thereof, more preferably selected from the group consisting of polymer membranes, inorganic membranes, palladium metal membranes and combinations of two or more thereof including composites or hybrids of two or more thereof, more preferably selected from the group consisting of polymer membranes and inorganic membranes and combinations of two or more thereof including composites of two or more thereof. More preferably, the at least one membrane comprised in membrane unit A are polymer membranes, inorganic membranes or hybrids, more preferably being polymer membranes or inorganic membranes.

It can be preferred that at least one membrane comprised in membrane unit A are metal membranes. In the context of the present invention, any metal membranes can be used as far as they permit to obtain a permeate gas stream P1 and a retentate gas stream R1, it is however preferred that the metal membranes disclosed in the foregoing are preferred. It is more preferred that the at least one membrane comprised in membrane unit A are palladium metal membranes.

Preferably the at least one membrane comprised in membrane unit A has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit A has a geometry of hollow fiber.

Preferably, the at least one membrane comprised in membrane unit A has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).

Preferably, the at least one membrane comprised in membrane unit A has a H₂/CH₄ selectivity of at least 10, preferably of at least 50, preferably of at least 75, more preferably of at least 100, more preferably of at least 150, more preferably of at least 175, more preferably of at least 200.

Preferably, the at least one membrane comprised in membrane unit A has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250.

Preferably, no vacuum apparatus is disposed downstream of the membrane unit A, preferably wherein no vacuum apparatus is disposed downstream of the unit (I) and upstream of the unit (II).

Preferably, according to (I) the unit further comprises
(I.e) a dividing means, connected to the exiting means according to (I.d), for dividing the retentate gas stream R1 into a gas stream S1 and a feed gas stream F2.

It can be preferred that, according to (I) the unit further comprises
(I.f) a means for heating one or more of a feed gas stream F1 according to (I.a), a permeate gas stream P1 according to (I.c), a retentate gas stream R1 according to (I.d) and a gas stream S1 according to (I.e), more preferably one or more of a feed gas stream F1 according to (I.a), a permeate gas stream P1 according to (I.c) and a retentate gas stream R1 according to (I.d), more preferably one or more of a permeate gas stream P1 according to (I.c) and a retentate gas stream R1 according to (I.d), more preferably a retentate gas stream R1 according to (I.d). Such means is preferably used when the membrane unit A is a metal membrane.

Preferably, in the unit (II), there is no compressor for compressing the gas exiting the unit (I), upstream of the membrane unit B.

Preferably, the membrane unit A has an inlet end and an outlet end, wherein the membrane unit B has an inlet end and an outlet end, wherein no compressor is located between the outlet end of the membrane unit A and the inlet end of the membrane unit B.

Preferably, the at least one membrane comprised in the membrane unit B is selected from the group consisting of polymer membranes, inorganic membranes, carbon membranes, metal membranes, proton-conducting ceramic membranes and combinations of two or more thereof including composites or hybrids of two or more thereof.

More preferably the at least one membrane comprised in membrane unit B is preferably selected from the group consisting of polymer membranes, inorganic membranes, carbon membranes, palladium metal membranes, proton-conducting ceramic membranes, and combinations of two or more thereof including composites or hybrids of two or more thereof, more preferably selected from the group consisting of polymer membranes, inorganic membranes, palladium metal membranes and combinations of two or more thereof including composites or hybrids of two or more thereof, more preferably selected from the group consisting of polymer membranes and inorganic membranes and combinations of two or more thereof including composites of two or more thereof. More preferably, the at least one membrane comprised in membrane unit B are polymer membranes, inorganic membranes or hybrids, more preferably being polymer membranes or inorganic membranes.

It can be preferred that the at least one membrane comprised in membrane unit B are metal membranes. In the context of the present invention, any metal membranes can be used as far as they permit to obtain a permeate gas stream P2 and a retentate gas stream R2, it is however preferred that the metal membranes disclosed in the foregoing are preferred. It is more preferred that the at least one membrane comprised in membrane unit B are palladium metal membranes.

Preferably the at least one membrane comprised in membrane unit B has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit B has a geometry of hollow fiber.

Preferably, the at least one membrane comprised in the membrane unit B has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).

Preferably, the at least one membrane comprised in membrane unit B has a H₂/CH₄ selectivity of at least 10, preferably of at least 50, more preferably of at least 75, more preferably of at least 100, more preferably of at least 150, more preferably of at least 175, more preferably of at least 200.

Preferably, the at least one membrane comprised in membrane unit B has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250.

Preferably, no vacuum apparatus is disposed downstream of the membrane unit B, preferably wherein no vacuum apparatus is disposed downstream of the unit (II) and upstream of the unit (III).

Preferably, the unit (II) further comprises
(II.e) a dividing means, connected to the exiting means according to (II.d), for dividing the retentate gas stream R2 into a gas stream S2 and a feed gas stream F3.

It is preferred that, according to (II) the unit further comprises
(II.f) a means for heating one or more of a feed gas stream F2 according to (II.a), a permeate gas stream P2 according to (II.c), a retentate gas stream R2 according to (II.d) and a gas stream S2 according to (II.e), more preferably one or more of a feed gas stream F2 according to (II.a), a permeate gas stream P2 according to (II.c) and a retentate gas stream R2 according to (II.d), more preferably one or more of a feed gas stream F2 according to (II.a) and a retentate gas stream R2 according to (II.d), more preferably a retentate gas stream R2 according to (II.d). Such means is preferably used when the membrane unit B is a metal membrane.

Preferably, in the unit (III), there is no compressor for compressing the gas exiting the unit (II), upstream of the membrane unit C.

It is preferred that, according to (III) the unit further comprises
(II.f) a means for heating one or more of a feed gas stream F3 according to (III.a), a permeate gas stream P3 according to (III.c) and a retentate gas stream R3 according to (III.d), more preferably one or more of a feed gas stream F3 according to (III.a) and a retentate gas stream R3 according to (III.d), more preferably a feed gas stream F3 according to (III.a). Such means is preferably used when the membrane unit B is a metal membrane.

Preferably, the membrane unit B has an inlet end and an outlet end, wherein the membrane unit C has an inlet end and an outlet end, wherein no compressor is located between the outlet end of the membrane unit B and the inlet end of the membrane unit C.

Preferably, the at least one membrane comprised in membrane unit C is selected from the group consisting of polymer membranes, inorganic membranes, carbon membranes, metal membranes, proton-conducting ceramic membranes and combinations of two or more thereof including composites or hybrids of two or more thereof.

More preferably the at least one membrane comprised in membrane unit C is preferably selected from the group consisting of polymer membranes, inorganic membranes, carbon membranes, palladium metal membranes, proton-conducting ceramic membranes, and combinations of two or more thereof including composites or hybrids of two or more thereof, more preferably selected from the group consisting of polymer membranes, inorganic membranes, palladium metal membranes and combinations of two or more thereof including composites or hybrids of two or more thereof, more preferably selected from the group consisting of polymer membranes and inorganic membranes and combinations of two or more thereof including composites of two or more thereof. More preferably, the at least one membrane comprised in membrane unit C are polymer membranes, inorganic membranes or hybrids, more preferably being polymer membranes or inorganic membranes.

It can be preferred that the at least one membrane comprised in membrane unit C are metal membranes. In the context of the present invention, any metal membranes can be used as far as they permit to obtain a permeate gas stream P3 and a retentate gas stream R3, it is however preferred that the metal membranes disclosed in the foregoing are preferred. It is more preferred that the at least one membrane comprised in membrane unit C are palladium metal membranes.

Preferably the at least one membrane comprised in membrane unit C has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit C has a geometry of hollow fiber.

Preferably, the at least one membrane comprised in membrane unit C has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).

Preferably, the at least one membrane comprised in membrane unit C has a H₂/CH₄ selectivity of at least 10, preferably of at least 50, more preferably of at least 75, more preferably of at least 100, more preferably of at least 150, more preferably of at least 175, more preferably of at least 200.

Preferably, the at least one membrane comprised in membrane unit C has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250.

Preferably no vacuum apparatus is disposed downstream of the membrane unit C, preferably wherein no vacuum apparatus is disposed downstream of the unit (III).

The present invention also further relates a process for the production of ammonia, comprising using a permeate gas stream P1 and/or P2, obtainable or obtained according to the inventive process, as a reductant. Preferably, prior to using the permeate gas stream P2, said permeate gas stream P2 is purified by means of a pressure swing adsorption. Preferably, the permeate gas stream P1 and/or P2 is obtainable or obtained from an apparatus according to the inventive apparatus.

The invention also further relates a process selected from the group consisting of acetylene production, methanol production, olefin production, power generation and combinations of two or more thereof comprising using a retentate gas R2 and/or R3, obtainable or obtained according to the inventive process, as a hydrocarbon source, preferably as a feed stock and/or fuel. Preferably, the permeate gas stream P1 and/or P2 is obtainable or obtained from the inventive apparatus.

In the context of the present invention, it is noted that the terms “metal membrane” and “palladium metal membrane” are preferably as defined in the foregoing relative to the membrane unit A such definitions being applicable to membrane units B and C as mentioned above.

The present invention is further illustrated by the following set of embodiments and combinations of embodiments resulting from the dependencies and back-references as indicated. In particular, it is noted that in each instance where a range of embodiments is mentioned, for example in the context of a term such as “any one of embodiments 1 to 4”, every embodiment in this range is meant to be explicitly disclosed for the skilled person, i.e. the wording of this term is to be understood by the skilled person as being synonymous to “any one of embodiments 1, 2, 3, and 4”.

Further, it is explicitly noted that the following set of embodiments is not the set of claims determining the extent of protection, but represents a suitably structured part of the description directed to general and preferred aspects of the present invention.
1. A process for separating H₂, preferably both H₂ and CH₄, from a gas mixture comprising H₂ and CH₄, the process comprising
   (i) a separation stage comprising
      (i.1) passing a feed gas stream F1 comprising H₂ and CH₄ at a molar ratio n(H₂):n(CH₄)=x(F1), 0<x(F1)≤0.5, through a membrane unit A comprising at least one membrane, the at least one membrane having a H₂/CH₄ selectivity of at least 10, at a pressure ratio ϕ across said at least one membrane, calculated as (pressure of feed gas stream F1/pressure of permeate gas stream P1) at constant temperature, of greater than 1, obtaining
         a permeate gas stream P1 comprising H₂ and CH₄ at a molar ratio n(H₂):n(CH₄)=x(P1); x(P1)>x(F1); and
         a retentate gas stream R1 comprising H₂ and CH₄ at a molar ratio n(H₂):n(CH₄)=x(R1); x(R1)<x(F1);
      (i.2) passing retentate gas stream R1 as a further feed gas stream F2 through a further separation stage, F2 having the same composition as R1;
   (ii) a further separation stage comprising
      (ii.1) passing F2 through a membrane unit B comprising at least one membrane, the at least one membrane having a H₂/CH₄ selectivity of at least 10, at a pressure ratio ϕ across said at least one membrane, calculated as (pressure of feed gas stream F2/pressure of permeate gas stream P2) at constant temperature, of greater than 1, obtaining
         a permeate gas stream P2 comprising H₂ and CH₄ at a molar ratio n(H₂):n(CH₄)=x(P2) of at least 1.4; x(P2)>x(F2); and
         a retentate gas stream R2 comprising H₂ and CH₄ at a molar ratio n(H₂):n(CH₄)=x(R2) of <0.17; x(R2)<x(F2);
      (ii.2) optionally passing retentate gas stream R2 as a further feed gas stream F3 through a further separation stage (iii), F3 having the same composition as R2;
   (iii) an optional further separation stage comprising
      (iii.1) passing F3 through a further membrane unit C comprising at least one membrane, the at least one membrane having a H₂/CH₄ selectivity of at least 10, at a pressure ratio ϕ across said at least one membrane (calculated as the (pressure of feed gas stream F3/pressure of permeate gas stream P3) at constant temperature), of greater than 1, obtaining
         a permeate gas stream P3 comprising H₂ and CH₄ at a molar ratio n(H₂):n(CH₄)=x(P3) of at least 0.39; x(P3)>x(F3); and
         a retentate gas stream R3 comprising H₂ and CH₄ at a molar ratio n(H₂):n(CH₄)=x(R3) of 0.01.
2. The process of embodiment 1, wherein no vacuum apparatus or compressor is operated downstream of the membrane unit A in the obtainment of the permeate gas streams and/or retentate gas streams, preferably in the obtainment of permeate gas stream P1 and/or retentate gas R1, wherein more preferably no vacuum apparatus or compressor is operated downstream of the membrane unit A.
3. The process of embodiment 1 or 2, wherein the at least one membrane comprised in membrane unit A has a H₂/CH₄ selectivity of at least 10, preferably of at least 50, more preferably of at least 75, more preferably of at least 100, more preferably of at least 150, more preferably of at least 175, more preferably of at least 200.
4. The process of any one of embodiments 1 to 3, wherein the at least one membrane comprised in membrane unit A has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250, more preferably in the range of from 200 to 250.
5. The process of any one of embodiments 1 to 4, wherein the at least one membrane comprised in membrane unit A is selected from the group consisting of polymer membranes, inorganic membranes, carbon membranes, palladium metal membranes, proton-conducting ceramic membranes, and combinations of two or more thereof including composites or hybrids of two or more thereof, preferably selected from the group consisting of polymer membranes and inorganic membranes and combinations of two or more thereof including composites of two or more thereof; and wherein preferably the at least one membrane comprised in membrane unit A has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit A has a geometry of hollow fiber.
6. The process of any one of embodiments 1 to 5, wherein the at least one membrane comprised in membrane unit A has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).
7. The process of any one of embodiments 1 to 6, wherein according to (i.1) the pressure ratio ϕ across the at least one membrane comprised in membrane unit A, calculated as (pressure of feed gas stream F1/pressure of permeate gas stream P1) at constant temperature, is of at least 4, preferably of at least 7 and/or preferably of at most 15, preferably of at most 12.
8. The process of any one of embodiments 1 to 6, wherein according to (i.1) the pressure ratio ϕ across the at least one membrane comprised in membrane unit A, calculated as (pressure of feed gas stream F1/pressure of permeate gas stream P1) at constant temperature, is in the range of from 1.5 to 25, more preferably in the range of from 2 to 20, more preferably in the range of from 2.5 to 16, more preferably in the range of from 3 to 15, more preferably in the range of from 3.5 to 14, more preferably in the range of from 4 to 13, more preferably in the range of from 4.5 to 12.
9. The process of any one of embodiments 1 to 8, wherein the mole ratio x(F1) is in the range of from 0.05 to 0.5, preferably in the range of from 0.1 to 0.4, more preferably in the range of from 0.15 to 0.4, more preferably in the range of from 0.2 to 0.3.
10. The process of any one of embodiments 1 to 9, wherein the feed gas stream F1 has a temperature in the range of from −30° C. to 60° C. , preferably in the range of from −15° C. to 50° C., more preferably in the range of from 0° C. to 40° C., more preferably in the range of from 5° C. to 35° C., more preferably in the range of from 15° C. to 30° C.
11. The process of any one of embodiments 1 to 10, wherein feed gas stream F1 has pressure in the range of from 5 to 100 bar (abs), preferably in the range of from 30 to 80 bar (abs), more preferably in the range of from 40 to 75 bar (abs), more preferably in the range of from 50 to 70 bar (abs).
12. The process of any one of embodiments 1 to 11, wherein according to (i.1) feed gas stream F1 has a mole ratio of the sum of H₂ and CH₄ to the total amount of all other components present in F1 in the range of from 5 to 99.99, wherein preferably feed gas stream F1 further has a mole ratio of hydrocarbons having 3 carbon atoms or less to the total amount of all other components present in F1 in the range of from 0 to 0.11, wherein preferably feed gas stream F1 further has a mole ratio of CO₂ to the total amount of all other components present in F1 in the range of from 0 to 0.04, wherein preferably feed gas stream F1 further has a mole ratio of trace gases to the total amount of all other components present in F1 in the range of from 0 to 0.01.
13. The process of any one of embodiments 1 to 12, wherein according to (i.1) feed gas stream F1 has a dynamic H₂ concentration, wherein preferably a dynamic H₂ concentration has a rate of change calculated as the molar ratio of H₂ to CH₄ per day in the range of from 0.000549 to 0.00549, preferably in the range of from 0.0011 to 0.0044, more preferably in the range of from 0.0016 to 0.0044, more preferably in the range of from 0.00219 to 0.00329; wherein preferably all values of mole ratio, pressure, pressure ratio, flow ratio and temperature refer to mean values calculated from the total sum of the respective individual values obtained over a 91 day season.
14. The process of any one of embodiments 1 to 13, wherein a source of feed gas stream F1 comprises, preferably consists of, CH₄ from natural gas and H₂ from one or more of water electrolysis, steam reformation, partial oxidation, radiolysis, biomass reformation, coal gasification, biomass gasification, fermentation, electrohydrogenesis, thermolysis, and photocatalytic water splitting, wherein preferably the source of feed gas stream F1 comprises, preferably consists of, CH₄ from natural gas and H₂ from one or more of water electrolysis, radiolysis, biomass reformation, biomass gasification, fermentation, electrohydrogenesis, thermolysis and photocatalytic water splitting, wherein more preferably the source of feed gas stream F1 comprises, preferably consists of, CH₄ from natural gas and H₂ from one or more of water electrolysis, biomass reformation, biomass gasification, fermentation, electrohydrogenesis, thermolysis and photocatalytic water splitting.
15. The process of any one of embodiments 1 to 14, wherein the mole ratio x(P1) is of at least 2, preferably of at least 3, more preferably of at least 5, more preferably of at least 9, preferably of at least 14, more preferably of at least 19.
16. The process of any one of embodiments 1 to 14, wherein the mole ratio x(P1) is in the range of from 2 to 2000, preferably in the range of from 3 to 1000, more preferably in the range of from 4 to 800, more preferably in the range of from 5 to 600, more preferably in the range of from 7 to 500, more preferably in the range of from 9 to 450, more preferably in the range of from 14 to 350, more preferably in the range of from 19 to 300.
17. The process of any one of embodiments 1 to 16, wherein the permeate gas stream P1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
18. The process of any one of embodiments 1 to 17, wherein the permeate gas stream P1 has a pressure in the range of from >1 to 50 bar(abs), preferably in the range of from >1.2 to 40 bar(abs), more preferably in the range of from 1.3 to 25 bar(abs), more preferably in the range of from 1.5 to 20 bar(abs), more preferably in the range of from 1.6 to 15 bar(abs), more preferably in the range of from 1.8 to 12 bar(abs), more preferably in the range of from 2 to 8 bar(abs).
19. The process of anyone of embodiments 1 to 18, wherein according to (i.1) the flow rate ratio of feed gas F1 to the permeate gas stream P1 calculated as (flow rate F1/flow rate P1) is in the range of from 2 to 250, more preferably in the range of from 5 to 220, more preferably in the range of from 10 to 210, more preferably in the range of from 15 to 205, more preferably in the range of from 20 to 200.
20. The process of any one of embodiments 1 to 19, wherein the mole ratio x(R1) is of at most 0.49, preferably of at most 0.39, preferably of at most 0.29, more preferably of at most 0.28.
21. The process of any one of embodiments 1 to 19, wherein the mole ratio x(R1) is in the range of from 0.045 to 0.49, more preferably in the range of from 0.095 to 0.39, more preferably in the range of from 0.13 to 0.29, more preferably in the range of from 0.145 to 0.28, more preferably in the range of from 0.15 to 0.26.
22. The process of any one of embodiments 1 to 21, wherein the retentate gas stream R1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
23. The process of any one of embodiments 1 to 22, wherein the retentate gas stream R1 has a pressure in the range of from 29.5 to 75.5 bar (abs), preferably in the range of from 39.5 to 74.5 bar (abs), more preferably in the range of from 45.5 to 69.5 bar (abs).
24. The process of anyone of embodiments 1 to 23, wherein according to (i.1) the flow rate ratio of feed gas F1 to the retentate gas stream R1 calculated as (flow rate F1/flow rate R1) is in the range of from >1 to 2, preferably in the range of from 1.005 to 1.9, more preferably in the range of from 1.05 to 1.8.
25. The process of anyone of embodiments 1 to 24, wherein the process further comprises
   (i.2) passing a portion, preferably all, of retentate gas stream R1 as a further feed gas stream F2 through a further separation stage, F2 having the same composition as R1.
26. The process of any one of embodiments 1 to 25, wherein the process further comprises
   (i.2) dividing retentate gas stream R1 in gas stream S1 and a further feed gas stream F2, S1 and F2 having the same composition as R1.
27. The process of embodiment 26, wherein from 0 to 99 wt.-%, preferably from 5 to 75 wt.-%, more preferably from 10 to 50 wt.-%, more preferably from 15 to 25 wt.-%, of the total amount of retentate gas stream R1 is divided into gas stream S1 and the remainder amount of retentate gas stream R1 into further feed gas F2, calculated as (weight of S1/weight of R1).
28. The process of any one of embodiments 26 or 27, wherein the gas stream S1 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
29. The process of any one of embodiments 26 to 28, wherein gas stream S1 has a pressure in the range of from 29.5 to 75.5 bar (abs), preferably in the range of from 39.5 to 74.5 bar (abs), more preferably in the range of from 45.5 to 69.5 bar (abs).
30. The process of any one of embodiments 1 to 29, wherein according to (ii.1), no compressor and/or vacuum apparatus operates between membrane unit A and membrane unit B and preferably no vacuum apparatus operates in the obtainment of permeate gas P2 and/or retentate gas R2.
31. The process of any one of embodiments 1 to 30, wherein the at least one membrane comprised in membrane unit B has a H₂/CH₄ selectivity of at least 10, preferably of at least 50, more preferably of at least 75, more preferably of at least 100, more preferably of at least 150, more preferably of at least 175, more preferably of at least 200.
32. The process of any one of embodiments 1 to 30, wherein the at least one membrane comprised in membrane unit B has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250.
33. The process of any one of embodiments 1 to 32, wherein the at least one membrane comprised in membrane unit B is selected from the group consisting of polymer membranes, inorganic membranes, carbon membranes, palladium metal membranes, proton-conducting ceramic membranes, and combinations of two or more thereof including composites or hybrids of two or more thereof, preferably selected from the group consisting of polymer membranes and inorganic membranes and combinations of two or more thereof including composites of two or more thereof; and wherein preferably the at least one membrane comprised in membrane unit B has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit B has a geometry of hollow fiber.
34. The process of any one of embodiments 1 to 33, wherein the at least one membrane comprised in membrane unit B has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).
35. The process of any one of embodiments 1 to 34, wherein according to (in) the pressure ratio ϕ across the at least one membrane comprised in membrane unit B, calculated as (pressure of feed gas stream F2/pressure of permeate gas stream P2) at constant temperature, is of at least 4, preferably of at least 7 and/or preferably of at most 50, preferably of at most 40.
36. The process of any one of embodiments 1 to 34, wherein according to (in) the pressure ratio ϕ across the at least one membrane comprised in membrane unit B, calculated as (pressure of feed gas stream F2/pressure of permeate gas stream P2) at constant temperature, is in the range of from 1.5 to 50, more preferably in the range of from 2 to 20, more preferably in the range of from 2.5 to16, more preferably in the range of from 3 to 15, more preferably in the range of from 3.5 to 14, more preferably in the range of from 4 to 13, more preferably in the range of from 4.5 to 12.
37. The process of any one of embodiments 1 to 36, wherein the mole ratio x(F2) is of at most 0.49, preferably of at most 0.39, preferably of at most 0.29, more preferably of at most 0.28.
38. The process of any one of embodiments 1 to 36, wherein the mole ratio x(F2) is in the range of from 0.045 to 0.49, more preferably in the range of from 0.095 to 0.39, more preferably in the range of from 0.13 to 0.29, more preferably in the range of from 0.145 to 0.28, more preferably in the range of from 0.15 to 0.26.
39. The process of any one of embodiments 1 to 38, wherein the feed gas stream F2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
40. The process of any one of embodiments 1 to 39, wherein feed gas stream F2 has a pressure in the range of from 4.5 to 99.5 bar (abs), preferably in the range of from 29.5 to 75.5 bar (abs), more preferably in the range of from 39.5 to 74.5 bar (abs), more preferably in the range of from 45.5 to 69.5 bar (abs).
41. The process of any one of embodiments 1 to 40, wherein the mole ratio x(P2) is of at least 1.5, preferably of at least 2.3, more preferably of at least 4, more preferably of at least 9.
42. The process of any one of embodiments 1 to 42, wherein the mole ratio x(P2) is in the range of from 1.5 to 1000, preferably in the range of from 2.3 to 100, more preferably in the range of from 4 to 50, more preferably in the range of from 5.6 to 20.
43. The process of any one of embodiments 1 to 42, wherein the permeate gas stream P2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
44. The process of any one of embodiments 1 to 43, wherein the permeate gas stream P2 has a pressure in the range of from >1 to 15 bar(abs), preferably in the range of from 1.2 to 14 bar(abs), more preferably in the range of from 1.3 to 13 bar(abs), more preferably in the range of from 3 to 11 bar(abs), more preferably in the range of from 4 to 8 bar(abs).
45. The process of anyone of embodiments 1 to 44, wherein according to (in) the flow rate ratio of feed gas F2 to the permeate gas stream P2 calculated as (flow rate F2/flow rate P2) is in the range of from 2 to 20 preferably in the range of from 3 to 15, more preferably in the range of from 4 to 11.
46. The process of any one of embodiments 1 to 45, wherein the mole ratio x(R2) is of at most 0.15, preferably of at most 0.13, more preferably of at most 0.12.
47. The process of any one of embodiments 1 to 45, wherein the mole ratio x(R2) is in the range of from 0.01 to 0.15, more preferably in the range of from 0.015 to 0.14, more preferably in the range of from 0.02 to 0.12.
48. The process of any one of embodiments 1 to 47, wherein the retentate gas stream R2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
49. The process of any one of embodiments 1 to 48, wherein the retentate gas stream R2 has a pressure in the range of from 29 to 75 bar (abs), preferably in the range of from 39 to 74 bar (abs), more preferably in the range of from 45 to 69 bar (abs).
50. The process of anyone of embodiments 1 to 49, wherein according to (in) the flow rate ratio of feed gas F2 to the retentate gas stream R2 calculated as (flow rate F2/flow rate R2) is in the range of from 1.05 to 2, preferably in the range of from 1.07 to 1.7, more preferably in the range of from 1.1 to 1.6.
51. The process of anyone of embodiments 1 to 50, wherein the process further comprises
   (ii.2) passing a portion, preferably all, of retentate gas stream R2 as a further feed gas stream F3 through a further separation stage, F3 having the same composition as R2.
52. The process of any one of embodiments 1 to 51, wherein the process further optionally comprises
   (ii.2) dividing retentate gas stream R2 in gas stream S2 and a further feed gas stream F2, S2 and F2 having the same composition as R2.
53. The process of embodiment 52, wherein from 0 to 99 wt.-%, preferably from 5 to 75 wt.-%, more preferably from 10 to 50 wt.-%, more preferably from 15 to 25 wt.-%, of the total amount of retentate gas stream R2 is divided into gas stream S2 and the remainder amount of retentate gas stream R2 into further feed gas F2, calculated as (weight of S2/weight of R2).
54. The process of any one of embodiments 52 or 53, wherein gas stream S2 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
55. The process of any one of embodiments 52 to 54, wherein gas stream S2 has a pressure in the range of from 29 to 75 bar (abs), preferably in the range of from 39 to 74 bar (abs), more preferably in the range of from 45 to 69 bar (abs).
56. The process of any one of embodiments 1 to 55, wherein according to (iii.1), no compressor and/or vacuum apparatus operates between membrane unit B and membrane unit C; and wherein preferably no vacuum apparatus operates in the obtainment of permeate gas P3 and/or retentate gas R3.
57. The process of any one of embodiments 1 to 56, wherein the at least one membrane comprised in membrane unit C has a H₂/CH₄ selectivity of at least 10, preferably of at least 50, more preferably of at least 75, more preferably of at least 100, more preferably of at least 150, more preferably of at least 175, more preferably of at least 200.
58. The process of any one of embodiments 1 to 56, wherein the at least one membrane comprised in membrane unit C has a H₂/CH₄ selectivity in the range of from 10 to 40 2500, preferably in the range of from 50 to 2000, more preferably in the range of from 75 to 1500, more preferably in the range of from 100 to 1000, more preferably in the range of from 150 to 500, more preferably in the range of from 175 to 250.
59. The process of any one of embodiments 1 to 58, wherein the at least one membrane comprised in membrane unit C is selected from the group consisting of polymer membranes, inorganic membranes, carbon membranes, palladium metal membranes, proton-conducting ceramic membranes, and combinations of two or more thereof including composites or hybrids of two or more thereof, preferably selected from the group consisting of polymer membranes and inorganic membranes and combinations of two or more thereof including composites of two or more thereof; and wherein preferably the at least one membrane comprised in membrane unit C has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit C has a geometry of hollow fiber.
60. The process of any one of embodiments 1 to 59, wherein the at least one membrane comprised in membrane unit C has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).
61. The process of any one of embodiments 1 to 60, wherein according to (iii.1) the pressure ratio ϕ across the at least one membrane comprised in membrane unit C, calculated as (pressure of feed gas stream F3/pressure of permeate gas stream P3) at constant temperature is of at least 20, preferably of at least 30, more preferably of at least 33, and/or preferably of at most 50, more preferably of at most 45, preferably of at most 42.
62. The process of any one of embodiments 1 to 60, wherein according to (iii.1) the pressure ratio ϕ across the at least one membrane comprised in membrane unit C, calculated as (pressure of feed gas stream F3/pressure of permeate gas stream P3) at constant temperature, is in the range of from 20 to 50, more preferably in the range of from 30 to 45, more preferably in the range of from 33 to 42.
63. The process of any one of embodiments 1 to 62, wherein the mole ratio x(F3) is of at most 0.15, preferably of at most 0.13, more preferably of at most 0.12.
64. The process of any one of embodiments 1 to 62, wherein the mole ratio x(F3) is in the range of from 0.01 to 0.15, more preferably in the range of from 0.015 to 0.14, more preferably in the range of from 0.02 to 0.12.
65. The process of any one of embodiments 1 to 64, wherein the feed gas stream F3 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
66. The process of any one of embodiments 1 to 65, wherein feed gas stream F3 has a pressure in the range of from 4 to 99 bar (abs), preferably in the range of from 29 to 75 bar (abs), more preferably in the range of from 39 to 74 bar (abs), more preferably in the range of from 45 to 69 bar (abs).
67. The process of any one of embodiments 1 to 66, wherein the mole ratio x(P3) is of at least 0.4, preferably of at least 0.7, more preferably of at least 0.8, more preferably of at least 1.8.
68. The process of any one of embodiments 1 to 66, wherein the mole ratio x(P3) is in the range of from 0.4 to 9, preferably in the range of from 0.7 to 5, more preferably in the range of from 0.8 to 4.9, more preferably in the range of from 1.8 to 4.5.
69. The process of any one of embodiments 1 to 68, wherein the permeate gas stream P3 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
70. The process of any one of embodiments 1 to 69, wherein the permeate gas stream P3 has a pressure in the range of from >1 to 5 bar(abs), preferably in the range of from 1.1 to 4 bar(abs), more preferably in the range of from 1.2 to 3 bar(abs).
71. The process of anyone of embodiments 1 to 70, wherein according to (iii.1) the flow rate ratio of feed gas F3 to the permeate gas stream P3 calculated as (flow rate F3/flow rate P3) is in the range of from 2.5 to 42 preferably in the range of from 5 to 35, more preferably in the range of from 10 to 20.
72. The process of any one of embodiments 1 to 71, wherein the mole ratio x(R3) is of at most 0.009, preferably of at most 0.005, more preferably of at most 0.002.
73. The process of any one of embodiments 1 to 71, wherein the mole ratio x(R3) is in the range of from 0.01 to 0.005, more preferably in the range of from 0.009 to 0.004, more preferably in the range of from 0.008 to 0.002.
74. The process of any one of embodiments 1 to 73, wherein the retentate gas stream R3 has a temperature in the range of from −30° C. to 60° C., preferably in the range of from −15° C. to 50° C., more preferably in the range of from 0° C. to 40° C., more preferably in the range of from 5° C. to 35° C., more preferably in the range of from 15° C. to 30° C.
75. The process of any one of embodiments 1 to 74, wherein the retentate gas stream R3 has a pressure in the range of from 28.5 to 74.5 bar (abs), preferably in the range of from 38.5 to 73.5 bar (abs), more preferably in the range of from 44.5 to 68.5 bar (abs).
76. The process of anyone of embodiments 1 to 75, wherein according to (iii.1) the flow rate ratio of feed gas F3 to the retentate gas stream R3 calculated as (flow rate F3/flow rate R3) is in the range of from 1.01 to 1.6, preferably in the range of from 1.05 to 1.4, more preferably in the range of from 1.09 to 1.3.
77. The process of anyone of embodiments 1 to 76, further comprising purifying one or more of the permeate gas stream P2 and the permeate stream P3.
78. An apparatus for separating H₂, preferably both H₂ and CH₄, from a gas mixture comprising H₂ and CH₄, the apparatus comprising
   (I) a unit comprising
      (I.a) a feeding means for passing a feed gas stream F1 comprising H₂ and CH₄ to a membrane unit A;
      (I.b) the membrane unit A connected to the feeding means for passing a feed gas stream F1 according to (I.a), said membrane unit comprising at least one membrane having a H₂/CH₄ selectivity of at least 10;
      (I.c) an exiting means connected to the membrane unit A, for removing a permeate gas stream P1 from the membrane unit A;
      (I.d) an exiting means connected to the membrane unit A for removing a retentate gas stream R1 from the membrane unit A;
   (II) a unit comprising
      (II.a) a feeding means, connected to the exiting means according to (I.d), for passing the gas stream R1 as a feed gas F2 to a membrane unit B;
      (II.b) the membrane unit B connected to the feeding means for passing a feed gas stream F2 according to (II.a), said membrane unit comprising at least one membrane having a H₂/CH₄ selectivity of at least 10;
      (II.c) an exiting means connected to the membrane unit B for removing a permeate stream P2 from the membrane unit B;
      (II.d) an exiting means connected to the membrane unit B for removing a retentate stream R2 from the membrane unit B;
   (III) optionally a unit comprising
      (III.a) a feeding means, connected to the exiting means according to (II.d), said feeding means for passing the gas stream F3 to a membrane unit C;
      (III.b) the membrane unit C connected to the feeding means according to (III.a), said membrane unit comprising at least one membrane having a H₂/CH₄ selectivity of at least 10;
      (III.c) an exiting means connected to the membrane unit C for removing a permeate stream P3 from the membrane unit C;
      (III.d) an exiting means connected to the membrane unit C for removing a retentate stream R3 from the membrane unit C.
79. The apparatus of embodiment 78, wherein said apparatus is for separating H₂, preferably both H₂ and CH₄, according to process embodiments 1 to 77.
80. The apparatus of embodiment 78 or 79, wherein, in unit (I), there is no compressor upstream of the membrane unit A.
81. The apparatus of any one of embodiments 78 to 80, having an inlet end and an outlet end, wherein the unit (I) has an inlet end and an outlet end, wherein the unit (I) is the first unit of the apparatus and wherein no compressor is located between the inlet end of the apparatus and the inlet end of the unit (I).
82. The apparatus of anyone of embodiments 78 to 81, wherein the at least one membrane comprised in the membrane unit A is selected from the group consisting of polymer membranes, inorganic membranes, carbon membranes, palladium metal membranes, proton-conducting ceramic membranes, and combinations of two or more thereof including composites or hybrids of two or more thereof, preferably selected from the group consisting of polymer membranes and inorganic membranes and combinations of two or more thereof including composites of two or more thereof; and wherein preferably the at least one membrane comprised in membrane unit A has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit A has a geometry of hollow fiber.
83. The apparatus of anyone of embodiments 78 to 82, wherein the at least one membrane comprised in membrane unit A has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).
84. The apparatus of anyone of embodiments 78 to 83, wherein the at least one membrane comprised in membrane unit A has a H₂/CH₄ selectivity of at least 10, preferably of at least 50, preferably of at least 75, more preferably of at least 100, more preferably of at least 150, more preferably of at least 175, more preferably of at least 200.
85. The apparatus of anyone of embodiments 78 to 83, wherein the at least one membrane comprised in membrane unit A has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250.
86. The apparatus of anyone of embodiments 78 to 85, wherein no vacuum apparatus is disposed downstream of the membrane unit A, preferably wherein no vacuum apparatus is disposed downstream of the unit (I) and upstream of the unit (II).
87. The apparatus of anyone of embodiments 78 to 86, wherein according to (I) the unit further comprises
   (I.e) a dividing means, connected to the exiting means according to (I.d), for dividing the retentate gas stream R1 into a gas stream S1 and a feed gas stream F2.
88. The apparatus of any one of embodiments 78 to 87, wherein, in the unit (II), there is no compressor for compressing the gas exiting the unit (I), upstream of the membrane unit B.
89. The apparatus of any one of embodiments 78 to 88, wherein the membrane unit A has an inlet end and an outlet end, wherein the membrane unit B has an inlet end and an outlet end, wherein no compressor is located between the outlet end of the membrane unit A and the inlet end of the membrane unit B.
90. The apparatus of anyone of embodiments 78 to 89, wherein the at least one membrane comprised in the membrane unit B is selected from the group consisting of polymer membranes, inorganic membranes, carbon membranes, palladium metal membranes, proton-conducting ceramic membranes, and combinations of two or more thereof including composites or hybrids of two or more thereof, preferably selected from the group consisting of polymer membranes and inorganic membranes and combinations of two or more thereof including composites of two or more thereof; and wherein preferably the at least one membrane comprised in membrane unit B has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit B has a geometry of hollow fiber.
91. The apparatus of anyone of embodiments 78 to 90, wherein the at least one membrane comprised in the membrane unit B has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).
92. The apparatus of anyone of embodiments 78 to 91, wherein the at least one membrane comprised in membrane unit B has a H₂/CH₄ selectivity of at least 10, preferably of at least 50, more preferably of at least 75, more preferably of at least 100, more preferably of at least 150, more preferably of at least 175, more preferably of at least 200.
93. The apparatus of anyone of embodiments 78 to 91, wherein the at least one membrane comprised in membrane unit B has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250.
94. The apparatus of anyone of embodiments 78 to 93, wherein no vacuum apparatus is disposed downstream of the membrane unit B, preferably wherein no vacuum apparatus is disposed downstream of the unit (II) and upstream of the unit (III).
95. The apparatus of anyone of embodiments 78 to 94, wherein the unit (II) further comprises
   (II.e) a dividing means, connected to the exiting means according to (II.d), for dividing the retentate gas stream R2 into a gas stream S2 and a feed gas stream F3.
96. The apparatus of any one of embodiments 78 to 95, wherein, in the unit (III), there is no compressor for compressing the gas exiting the unit (II), upstream of the membrane unit C.
97. The apparatus of any one of embodiments 78 to 96, wherein the membrane unit B has an inlet end and an outlet end, wherein the membrane unit C has an inlet end and an outlet end, wherein no compressor is located between the outlet end of the membrane unit B and the inlet end of the membrane unit C.
98. The apparatus of anyone of embodiments 78 to 97, wherein the at least one membrane comprised in membrane unit C is selected from the group consisting of polymer membranes, inorganic membranes, carbon membranes, palladium metal membranes, proton-conducting ceramic membranes, and combinations of two or more thereof including composites or hybrids of two or more thereof, preferably selected from the group consisting of polymer membranes and inorganic membranes and combinations of two or more thereof including composites of two or more thereof; and wherein preferably the at least one membrane comprised in membrane unit C has a geometry selected from the group consisting of spiral-wound, hollow fiber, plate-and-frame and multichannel tubular including combinations of two or more thereof, preferably a geometry selected from the group consisting of spiral-wound, hollow fiber and plate-and-frame including combinations of two or more thereof, more preferably a geometry selected from the group consisting of spiral-wound and hollow fiber and combinations thereof, more the at least one membrane comprised in membrane unit C has a geometry of hollow fiber.
99. The apparatus of anyone of embodiments 78 to 98, wherein the at least one membrane comprised in membrane unit C has a H₂ permeance in the range of from 0.1 to 100 Nm³/(m² h bar), preferably in the range of from 0.5 to 75 Nm³/(m² h bar), more preferably in the range of from 1 to 50 Nm³/(m² h bar), more preferably in the range of from 2 to 40 Nm³/(m² h bar), more preferably in the range of from 3 to 30 Nm³/(m² h bar), more preferably in the range of from 4 to 20 Nm³/(m² h bar), more preferably in the range of from 5 to 10 Nm³/(m² h bar).
100. The apparatus of anyone of embodiments 78 to 99, wherein the at least one membrane comprised in membrane unit C has a H₂/CH₄ selectivity of at least 10, preferably of at least 50, more preferably of at least 75, more preferably of at least 100, more preferably of at least 150, more preferably of at least 175, more preferably of at least 200.
101. The apparatus of anyone of embodiments 78 to 99, wherein the at least one membrane comprised in membrane unit C has a H₂/CH₄ selectivity in the range of from 10 to 2500, preferably in the range of from 50 to 2000, more preferably in the range of from 75 to 1500, more preferably in the range of from 100 to 1000, more preferably in the range of from 150 to 500, more preferably in the range of from 175 to 250.
102. The apparatus of anyone of embodiments 78 to 101, wherein no vacuum apparatus is disposed downstream of the membrane unit C, preferably wherein no vacuum apparatus is disposed downstream of the unit (III).
103. A process for the production of ammonia, comprising
   using a permeate gas stream P1 and/or P2, obtainable or obtained according to a process according to any one of embodiments 1 to 77, as a reductant.
104. The process of embodiment 103, wherein prior to using the permeate gas stream P2, said permeate gas stream P2 is purified by means of a pressure swing adsorption.
105. The process of embodiment 103 or 104, wherein the permeate gas stream P1 and/or P2 is obtainable or obtained from an apparatus according to any one of embodiments 78 to 102.
106. A process selected from the group consisting of acetylene production, methanol production, olefin production, power generation and combinations of two or more thereof comprising
   using a retentate gas R2 and/or R3, obtainable or obtained according to a process according to any one of embodiments 1 to 77, as a hydrocarbon source, preferably as a feed stock and/or fuel.
107. The process of embodiment 106, wherein the permeate gas stream P1 and/or P2 is obtainable or obtained from an apparatus according to any one of embodiments 78 to 102.

### EXAMPLES

### Reference Example 1 Membrane Selection

The following considerations were made in selecting membranes.

The pressure ratio and selectivity are defined as follows:

$$φ = \frac{{p}_{feed}}{{p}_{permeate}} \qquad ( 1 )$$

$$α = \frac{{N}_{{H}_{2}}}{{N}_{C {H}_{4}}} = \frac{{J}_{{H}_{2}} / ( {\overline{p}}_{{H}_{2}}^{feed , retentate} - {p}_{{H}_{2}}^{p e r m e a t e} )}{{J}_{C {H}_{4}} / ( {\overline{p}}_{C {H}_{4}}^{f e e d , r e t e n t a t e} - {p}_{C {H}_{4}}^{p e r m e a t e} )} \qquad ( 1 )$$

where N denotes the permeance of a certain component (pressure-normalized flux). Tests for permeate pressures of atmospheric pressures and higher. For the membrane selectivities, four scenarios were used having an α value of 10, 50, 200 and 2000.

In the context of the present invention membrane selectivity, also often termed permselectivity in the prior art, represented as α according to equation (2), is defined herein as the ratio of the permeances of hydrogen and methane, calculated as (Permeance H₂:Permeance CH₄).

In the context of the present invention permeance, preferably H₂ membrane permeance, is defined herein as the ratio of the flux of H₂ to the driving force across the membrane calculated as described in equation 2. Likewise the permeance, preferably CH₄ membrane permeance, is also defined herein as the ratio of the flux of CH₄ to the driving force across the membrane calculated as above.

Reference Example 2 Simulation Conditions

The performance of membrane stages was simulated using Matlab (version R2019b). The permeate concentration Cₚ, permeate and retentate flow rate ratios, stage cut (θ)) were calculated by using the equations below derived from the procedure outlined by Saltonstall, C. W., “Calculation of the membrane area required for gas separations”, Journal of Membrane Science, 1987, Volume 32, Issues 2-3, pages 185 to 193 for binary mixtures. Here, the mixture was assumed to consist of two components, hydrogen and methane, with mole fractions n_{H2} and n_{CH4}, respectively—n_{H2}=mol H₂/(mol H₂+mol CH₄). The permeance of the two components was assumed to be constant, i.e. independent of concentrations. To perform the calculations, for every membrane stage, the feed stream parameters (flow rate, composition, pressure), retentate stream parameters (pressure, desired composition), permeate stream parameter (pressure), and selectivity where used as input. This results in 3 independent simulations for the membrane stages A, B, and C.

$${n}_{{i}_{permeate}} = \frac{{n}_{{i}_{feed}} - {n}_{{i}_{retentate}}}{θ} + {n}_{{i}_{retentate}} \qquad ( 3 )$$

$$θ = 1 - \frac{( Ω + 1 - {y}_{ret} )}{( Ω + 1 - {y}_{feed} )} \cdot {( \frac{1 - {y}_{ret}}{1 - {y}_{feed}} )}^{( \frac{1 - ( Ω + 1 ) φ}{φ - 1} )} \cdot {( \frac{{y}_{ret}}{{y}_{feed}} )}^{( \frac{( Ω + 1 ) φ}{φ - 1} - 1 )} \qquad ( 4 )$$

$$Where :$$

$$Ω = \frac{1}{α - 1} \qquad ( 5 )$$

$$And :$$

$${y}_{feed} = \frac{φ}{2} ( {A}_{feed} - \sqrt{{A}_{feed}^{2} - 4 \cdot {B}_{feed}} ) \qquad ( 6.1 )$$

$${y}_{ret} = \frac{φ}{2} ( {A}_{ret} - \sqrt{{A}_{ret}^{2} - 4 \cdot {B}_{ret}} ) \qquad ( 6.2 )$$

$${A}_{feed} = {n}_{feed} + \frac{1}{φ} + Ω \qquad ( 6.3 )$$

$${A}_{ret} = {n}_{ret} + \frac{1}{φ} + Ω \qquad ( 6.4 )$$

$${B}_{feed} = α \cdot {n}_{feed} + \frac{Ω}{φ} \qquad ( 6.5 )$$

$${B}_{ret} = α \cdot {n}_{ret} + \frac{Ω}{φ} \qquad ( 6.6 )$$

Next, the membrane stages were coupled by setting the feed to stage (ii) (F2) equal to the retentate of stage (i) (R1) (i.e., assuming S1=0). A pressure drop from feed to retentate of 0.5 bar per membrane stage was assumed (for example, R1=F1−0.5 bar). The simulations were performed using a fixed H₂ permeance of 1 Nm³/(m² h bar). Next, a parameter variation was performed for the following parameters:
Membrane selectivity (four α values: 10, 50, 200, and 2000);
Permeate pressure of stage (i) (5 values: 1.3, 5, 7.5, 10, 25 bar (absolute));
H₂ retentate mole fraction of H₂ in mixtures consisting of H₂ and CH₄ in R1 (many values: C_{R1}=C_{F1}·x, where x=0.58-0.98 with steps of 0.04);
Retentate mole fraction of H₂ in mixtures consisting of H₂ and CH₄ in R2 (4 values: 0.025, 0.05, 0.075, 0.10) (based on a maximum of 10% for sending the retentate to a power plant);

The feed composition and pressure were kept constant at 20% hydrogen and 51 bar. This simulation gives a total of 3520 different scenarios, summarized in the statistic parameters given in tables 1 to 4. The membranes and different feed streams are illustrated in FIG. 1.

### Discussion of Tables

Tables 1 to 4 each relate general statistic parameters of the results obtained for all three stages operating in series with membranes having hydrogen selectivities of 10, 50, 200 and 2000 respectively, each membrane unit of the series using the same membrane selectivity. Shown in said tables are the maximum and minimum values as well as mean and median values for the entire ensemble of membrane units per simulated selectivity. All values in grey boxes were held constant and all values in black and white were allowed to vary. Results given in the simulations with respect to the hydrogen and methane concentrations were obtained in mole fraction defined as (H₂ conc./total sum H₂ and CH₄ conc.) which were then converted to mole ratio as shown in all tables defined as (H₂ conc./CH₄ conc.).

Tables 5 to 8 each relate specific examples representitive of the simulations with the membrane selectivity of all three membrane units indicated under the example number. All values given in grey boxes have been held constant and values in black and white were allowed to vary.

As may be taken from the results in all tables, higher pressures of permeate stream P1 having purity of H₂ correlated with increasing selectivity. This is apparent in a general sense by observing the median and mean values for P1 in Tables 1 to 4. As can be seen, the purest hydrogen at the highest possible pressure is obtained from the first stage and the separation becomes more difficult as hydrogen is removed in the further stages. However, these intermediate purities can be further purified by pressure swing adsorption or used in heating, or even recycled into the source. However, recycling intermediate mixtures would likely require compressor stages. Furthermore, R3 has been calculated as invariable and thus purified methane is also obtained for all membrane scenarios. Thus all streams are applicable to both synthetic processes and power generation needs. This is also reflected in the results given in Tables 5 to 8 which show excellent purities for both hydrogen and methane even for membranes having a selectivity of 50.

TABLE 1
Endpoint and midpoint values of simulations
for membranes with a selectivity 10

| Stream | units | Max | Min | Median | Mean |
|---|---|---|---|---|---|
| F1 | mole ratio (H₂/CH₄) | 0.25 | 0.25 | 0.25 | 0.25 |
| F1 | mole % (H₂/H₂ + CH₄) | 0.20 | 0.20 | 0.20 | 0.20 |
| F1 | pressure bar (abs) | 51 | 51 | 51 | 51 |
| R1 | mole ratio (H₂/CH₄) | 0.244 | 0.131 | 0.185 | 0.185 |
| R1 | mole % (H₂/H₂ + CH₄) | 0.196 | 0.116 | 0.156 | 0.156 |
| R1 | pressure bar (abs) | 50.5 | 50.5 | 50.5 | 50.5 |
| F1/R1 | flow ratio (Nm³h⁻¹/ | 1.990 | 1.008 | 1.133 | 1.159 |
| | Nm³h⁻¹) | | | | |
| P1 | mole ratio (H₂/CH₄) | 2.270 | 0.398 | 1.261 | 1.127 |
| P1 | mole % (H₂/H₂ + CH₄) | 0.694 | 0.285 | 0.558 | 0.530 |
| F1/P1 | ϕ (bar/bar) (abs) | 39.2 | 2.0 | 6.8 | 5.2 |
| F1/P1 | flow ratio (Nm³h⁻¹/ | 124.552 | 2.010 | 8.498 | 7.271 |
| | Nm³h⁻¹) | | | | |
| F2 | mole ratio (H₂/CH₄) | 0.244 | 0.131 | 0.185 | 0.185 |
| F2 | mole % (H₂/H₂ + CH₄) | 0.196 | 0.116 | 0.156 | 0.156 |
| F2 | pressure bar (abs) | 50.5 | 50.5 | 50.5 | 50.5 |
| R2 | mole ratio (H₂/CH₄) | 0.111 | 0.026 | 0.067 | 0.067 |
| R2 | mole % (H₂/H₂ + CH₄) | 0.100 | 0.025 | 0.063 | 0.063 |
| R2 | pressure bar (abs) | 50 | 50 | 50 | 50 |
| F2/R2 | flow ratio (Nm³h⁻¹/ | 1.909 | 1.235 | 1.407 | 1.407 |
| | Nm³h⁻¹) | | | | |
| P2 | mole ratio (H₂/CH₄) | 1.532 | 0.276 | 0.670 | 0.682 |
| P2 | mole % (H₂/H₂ + CH₄) | 0.605 | 0.216 | 0.401 | 0.405 |
| F2/P2 | ϕ (bar/bar) (abs) | 38.8 | 5.0 | 8.1 | 8.5 |
| F2/P2 | flow ratio (Nm³h⁻¹/ | 13.68 | 1.36 | 2.65 | 2.46 |
| | Nm³h⁻¹) | | | | |
| F3 | mole ratio (H₂/CH₄) | 0.111 | 0.026 | 0.067 | 0.067 |
| F3 | mole % (H₂/H₂ + CH₄) | 0.100 | 0.025 | 0.0625 | 0.0625 |
| F3 | pressure bar (abs) | 50 | 50 | 50 | 50 |
| R3 | mole ratio (H₂/CH₄) | 0.01 | 0.01 | 0.01 | 0.01 |
| R3 | mole % (H₂/H₂ + CH₄) | 0.01 | 0.01 | 0.01 | 0.01 |
| R3 | pressure bar (abs) | 49.5 | 49.5 | 49.5 | 49.5 |
| F3/R3 | flow ratio (Nm³h⁻¹/ | 1.517 | 1.154 | 1.339 | 1.356 |
| | Nm³h⁻¹) | | | | |
| P3 | mole ratio (H₂/CH₄) | 0.377 | 0.139 | 0.259 | 0.253 |
| P3 | mole % (H₂/H₂ + CH₄) | 0.274 | 0.122 | 0.206 | 0.202 |
| F3/P3 | ϕ (bar/bar) (abs) | 38.5 | 38.5 | 38.5 | 38.5 |
| F3/P3 | flow ratio (Nm³h⁻¹/ | 7.485 | 2.931 | 3.926 | 3.810 |
| | Nm³h⁻¹) | | | | |

TABLE 2
Endpoint and midpoint values of simulations
for membranes with a selectivity 50

| Stream | units | Max | Min | Median | Mean |
|---|---|---|---|---|---|
| F1 | mole ratio (H₂/CH₄) | 0.25 | 0.25 | 0.25 | 0.25 |
| F1 | mole % (H₂/H₂ + CH₄) | 0.20 | 0.20 | 0.20 | 0.20 |
| F1 | pressure bar (abs) | 51 | 51 | 51 | 51 |
| R1 | mole ratio (H₂/CH₄) | 0.244 | 0.131 | 0.185 | 0.185 |
| R1 | mole % (H₂/H₂ + CH₄) | 0.196 | 0.116 | 0.156 | 0.156 |
| R1 | pressure bar (abs) | 50.5 | 50.5 | 50.5 | 50.5 |
| F1/R1 | flow ratio (Nm³h⁻¹/ | 1.742 | 1.006 | 1.086 | 1.110 |
| | Nm³h⁻¹) | | | | |
| P1 | mole ratio (H₂/CH₄) | 10.917 | 0.456 | 3.815 | 2.578 |
| P1 | mole % (H₂/H₂ + CH₄) | 0.916 | 0.313 | 0.792 | 0.720 |
| F1/P1 | ϕ (bar/bar) (abs) | 39.2 | 2.0 | 6.8 | 5.2 |
| F1/P1 | flow ratio (Nm³h⁻¹/ | 180.022 | 2.347 | 12.633 | 10.087 |
| | Nm³h⁻¹) | | | | |
| F2 | mole ratio (H₂/CH₄) | 0.244 | 0.131 | 0.185 | 0.185 |
| F2 | mole % (H₂/H₂ + CH₄) | 0.196 | 0.116 | 0.156 | 0.156 |
| F2 | pressure bar (abs) | 50.5 | 50.5 | 50.5 | 50.5 |
| R2 | mole ratio (H₂/CH₄) | 0.111 | 0.026 | 0.067 | 0.067 |
| R2 | mole % (H₂/H₂ + CH₄) | 0.100 | 0.025 | 0.063 | 0.063 |
| R2 | pressure bar (abs) | 50 | 50 | 50 | 50 |
| F2/R2 | flow ratio (Nm³h⁻¹/ | 1.543 | 1.141 | 1.209 | 1.230 |
| | Nm³h⁻¹) | | | | |
| P2 | mole ratio (H₂/CH₄) | 7.111 | 0.396 | 1.520 | 1.581 |
| P2 | mole % (H₂/H₂ + CH₄) | 0.877 | 0.284 | 0.603 | 0.613 |
| F2/P2 | ϕ (bar/bar) (abs) | 38.8 | 5.0 | 8.1 | 8.5 |
| F2/P2 | flow ratio (Nm³h⁻¹/ | 29.56 | 1.94 | 4.99 | 4.34 |
| | Nm³h⁻¹) | | | | |
| F3 | mole ratio (H₂/CH₄) | 0.111 | 0.026 | 0.067 | 0.067 |
| F3 | mole % (H₂/H₂ + CH₄) | 0.100 | 0.025 | 0.0625 | 0.0625 |
| F3 | pressure bar (abs) | 50 | 50 | 50 | 50 |
| R3 | mole ratio (H₂/CH₄) | 0.01 | 0.01 | 0.01 | 0.01 |
| R3 | mole % (H₂/H₂ + CH₄) | 0.01 | 0.01 | 0.01 | 0.01 |
| R3 | pressure bar (abs) | 49.5 | 49.5 | 49.5 | 49.5 |
| F3/R3 | flow ratio (Nm³h⁻¹/ | 1.194 | 1.054 | 1.130 | 1.129 |
| | Nm³h⁻¹) | | | | |
| P3 | mole ratio (H₂/CH₄) | 1.294 | 0.439 | 0.860 | 0.813 |
| P3 | mole % (H₂/H₂ + CH₄) | 0.564 | 0.305 | 0.462 | 0.448 |
| F3/P3 | ϕ (bar/bar) (abs) | 38.5 | 38.5 | 38.5 | 38.5 |
| F3/P3 | flow ratio (Nm³h⁻¹/ | 19.675 | 6.157 | 9.700 | 8.747 |
| | Nm³h⁻¹) | | | | |

TABLE 3
Endpoint and midpoint values of simulations
for membranes with a selectivity 200

| stream | units | Max | Min | Median | Mean |
|---|---|---|---|---|---|
| F1 | mole ratio (H₂/CH₄) | 0.25 | 0.25 | 0.25 | 0.25 |
| F1 | mole % (H₂/H₂ + CH₄) | 0.20 | 0.20 | 0.20 | 0.20 |
| F1 | pressure bar (abs) | 51 | 51 | 51 | 51 |
| R1 | mole ratio (H₂/CH₄) | 0.244 | 0.131 | 0.185 | 0.185 |
| R1 | mole % (H₂/H₂ + CH₄) | 0.196 | 0.116 | 0.156 | 0.156 |
| R1 | pressure bar (abs) | 50.5 | 50.5 | 50.5 | 50.5 |
| F1/R1 | flow ratio (Nm³h⁻¹/ | 1.702 | 1.005 | 1.072 | 1.099 |
| | Nm³h⁻¹) | | | | |
| P1 | mole ratio (H₂/CH₄) | 43.194 | 0.470 | 10.348 | 4.001 |
| P1 | mole % (H₂/H₂ + CH₄) | 0.977 | 0.320 | 0.912 | 0.800 |
| F1/P1 | ϕ (bar/bar) (abs) | 39.2 | 2.0 | 6.8 | 5.2 |
| F1/P1 | flow ratio (Nm³h⁻¹/ | 195.343 | 2.425 | 14.945 | 11.095 |
| | Nm³h⁻¹) | | | | |
| F2 | mole ratio (H₂/CH₄) | 0.244 | 0.131 | 0.185 | 0.185 |
| F2 | mole % (H₂/H₂ + CH₄) | 0.196 | 0.116 | 0.156 | 0.156 |
| F2 | pressure bar (abs) | 50.5 | 50.5 | 50.5 | 50.5 |
| R2 | mole ratio (H₂/CH₄) | 0.111 | 0.026 | 0.067 | 0.067 |
| R2 | mole % (H₂/H₂ + CH₄) | 0.100 | 0.025 | 0.063 | 0.063 |
| R2 | pressure bar (abs) | 50 | 50 | 50 | 50 |
| F2/R2 | flow ratio (Nm³h⁻¹/ | 1.481 | 1.125 | 1.171 | 1.194 |
| | Nm³h⁻¹) | | | | |
| P2 | mole ratio (H₂/CH₄) | 27.718 | 0.439 | 2.397 | 2.423 |
| P2 | mole % (H₂/H₂ + CH₄) | 0.965 | 0.305 | 0.706 | 0.708 |
| F2/P2 | ϕ (bar/bar) (abs) | 38.8 | 5.0 | 8.1 | 8.5 |
| F2/P2 | flow ratio (Nm³h⁻¹/ | 35.83 | 2.14 | 6.09 | 5.16 |
| | Nm³h⁻¹) | | | | |
| F3 | mole ratio (H₂/CH₄) | 0.111 | 0.026 | 0.067 | 0.067 |
| F3 | mole % (H₂/H₂ + CH₄) | 0.100 | 0.025 | 0.0625 | 0.0625 |
| F3 | pressure bar (abs) | 50 | 50 | 50 | 50 |
| R3 | mole ratio (H₂/CH₄) | 0.01 | 0.01 | 0.01 | 0.01 |
| R3 | mole % (H₂/H₂ + CH₄) | 0.01 | 0.01 | 0.01 | 0.01 |
| R3 | pressure bar (abs) | 49.5 | 49.5 | 49.5 | 49.5 |
| F3/R3 | flow ratio (Nm³h⁻¹/ | 1.136 | 1.034 | 1.091 | 1.087 |
| | Nm³h⁻¹) | | | | |
| P3 | mole ratio (H₂/CH₄) | 3.187 | 0.870 | 1.967 | 1.763 |
| P3 | mole % (H₂/H₂ + CH₄) | 0.761 | 0.465 | 0.663 | 0.638 |
| F3/P3 | ϕ (bar/bar) (abs) | 38.5 | 38.5 | 38.5 | 38.5 |
| F3/P3 | flow ratio (Nm³h⁻¹/ | 30.344 | 8.346 | 14.581 | 12.432 |
| | Nm³h⁻¹) | | | | |

TABLE 4
Endpoint and midpoint values of simulations
for membranes with a selectivity 2000

| stream | units | Max | Min | Median | Mean |
|---|---|---|---|---|---|
| F1 | mole ratio (H₂/CH₄) | 0.25 | 0.25 | 0.25 | 0.25 |
| F1 | mole % (H₂/H₂ + CH₄) | 0.20 | 0.20 | 0.20 | 0.20 |
| F1 | pressure bar (abs) | 51 | 51 | 51 | 51 |
| R1 | mole ratio (H₂/CH₄) | 0.244 | 0.131 | 0.185 | 0.185 |
| R1 | mole % (H₂/H₂ + CH₄) | 0.196 | 0.116 | 0.156 | 0.156 |
| R1 | pressure bar (abs) | 50.5 | 50.5 | 50.5 | 50.5 |
| F1/R1 | flow ratio (Nm³h⁻¹/ | 1.690 | 1.005 | 1.065 | 1.095 |
| | Nm³h⁻¹) | | | | |
| P1 | mole ratio (H₂/CH₄) | 430.365 | 0.474 | 69.685 | 5.341 |
| P1 | mole % (H₂/H₂ + CH₄) | 0.998 | 0.322 | 0.986 | 0.842 |
| F1/P1 | ϕ (bar/bar) (abs) | 39.2 | 2.0 | 6.8 | 5.2 |
| F1/P1 | flow ratio (Nm³h⁻¹/ | 200.420 | 2.450 | 16.278 | 11.574 |
| | Nm³h⁻¹) | | | | |
| F2 | mole ratio (H₂/CH₄) | 0.244 | 0.131 | 0.185 | 0.185 |
| F2 | mole % (H₂/H₂ + CH₄) | 0.196 | 0.116 | 0.156 | 0.156 |
| F2 | pressure bar (abs) | 50.5 | 50.5 | 50.5 | 50.5 |
| R2 | mole ratio (H₂/CH₄) | 0.111 | 0.026 | 0.067 | 0.067 |
| R2 | mole % (H₂/H₂ + CH₄) | 0.100 | 0.025 | 0.063 | 0.063 |
| R2 | pressure bar (abs) | 50 | 50 | 50 | 50 |
| F2/R2 | flow ratio (Nm³h⁻¹/ | 1.463 | 1.120 | 1.154 | 1.180 |
| | Nm³h⁻¹) | | | | |
| P2 | mole ratio (H₂/CH₄) | 274.567 | 0.455 | 3.327 | 3.130 |
| P2 | mole % (H₂/H₂ + CH₄) | 0.996 | 0.313 | 0.769 | 0.758 |
| F2/P2 | ϕ (bar/bar) (abs) | 38.8 | 5.0 | 8.1 | 8.5 |
| F2/P2 | flow ratio (Nm³h⁻¹/ | 38.22 | 2.23 | 6.73 | 5.57 |
| | Nm³h⁻¹) | | | | |
| F3 | mole ratio (H₂/CH₄) | 0.111 | 0.026 | 0.067 | 0.067 |
| F3 | mole % (H₂/H₂ + CH₄) | 0.100 | 0.025 | 0.0625 | 0.0625 |
| F3 | pressure bar (abs) | 50 | 50 | 50 | 50 |
| R3 | mole ratio (H₂/CH₄) | 0.01 | 0.01 | 0.01 | 0.01 |
| R3 | mole % (H₂/H₂ + CH₄) | 0.01 | 0.01 | 0.01 | 0.01 |
| R3 | pressure bar (abs) | 49.5 | 49.5 | 49.5 | 49.5 |
| F3/R3 | flow ratio (Nm³h⁻¹/ | 1.114 | 1.026 | 1.077 | 1.071 |
| | Nm³h⁻¹) | | | | |
| P3 | mole ratio (H₂/CH₄) | 8.077 | 1.490 | 4.464 | 3.557 |
| P3 | mole % (H₂/H₂ + CH₄) | 0.890 | 0.598 | 0.817 | 0.781 |
| F3/P3 | ϕ (bar/bar) (abs) | 38.5 | 38.5 | 38.5 | 38.5 |
| F3/P3 | flow ratio (Nm³h⁻¹/ | 39.230 | 9.776 | 18.645 | 15.088 |
| | Nm³h⁻¹) | | | | |

TABLE 5
Simulated results of examples 1 to 5.

| All | | Example | | | | |
|---|---|---|---|---|---|---|
| Stages | membrane selectivity (α) | 1 | 2 | 3 | 4 | 5 |
| Stream | units | 10 | 10 | 50 | 50 | 50 |
| F1 | mole ratio (H₂/CH₄) | 0.25 | 0.25 | 0.25 | 0.25 | 0.25 |
| F1 | mole % (H₂/H₂ + CH₄) | 0.20 | 0.20 | 0.20 | 0.20 | 0.20 |
| F1 | pressure bar (abs) | 51 | 51 | 51 | 51 | 51 |
| F1/R1 | flow ratio (Nm³h⁻¹/Nm³3h⁻¹) | 1.0081 | 1.0091 | 1.0056 | 1.0059 | 1.0059 |
| R1 | mole ratio (H₂/CH₄) | 0.244 | 0.244 | 0.244 | 0.244 | 0.244 |
| R1 | mole % (H₂/H₂ + CH₄) | 0.196 | 0.196 | 0.196 | 0.196 | 0.196 |
| R1 | pressure bar (abs) | 50.5 | 50.5 | 50.5 | 50.5 | 50.5 |
| P1 | mole ratio (H₂/CH₄) | 2.27 | 1.77 | 10.92 | 7.09 | 7.09 |
| P1 | mole % (H₂/H₂ + CH₄) | 0.694 | 0.639 | 0.916 | 0.876 | 0.876 |
| F1/P1 | ϕ (bar/bar) (abs) | 39.2 | 10.2 | 39.2 | 10.2 | 10.2 |
| F1/P1 | flow ratio (Nm³h⁻¹/Nm³h⁻¹) | 124.6 | 110.6 | 180.0 | 170.1 | 170.1 |
| F2 | mole ratio (H₂/CH₄) | 0.244 | 0.244 | 0.244 | 0.244 | 0.244 |
| F2 | mole % (H₂/H₂ + CH₄) | 0.196 | 0.196 | 0.196 | 0.196 | 0.196 |
| F2 | pressure bar (abs) | 50.5 | 50.5 | 50.5 | 50.5 | 50.5 |
| F2/R2 | flow ratio (Nm³h⁻¹/Nm³h⁻¹) | 1.235 | 1.235 | 1.141 | 1.141 | 1.161 |
| R2 | mole ratio (H₂/CH₄) | 0.11 | 0.11 | 0.11 | 0.11 | 0.11 |
| R2 | mole % (H₂/H₂ + CH₄) | 0.10 | 0.10 | 0.10 | 0.10 | 0.10 |
| R2 | pressure bar (abs) | 50 | 50 | 50 | 50 | 50 |
| P2 | mole ratio (H 2/CH₄) | 1.532 | 1.532 | 7.111 | 7.111 | 3.808 |
| P2 | mole % (H₂/H₂ + CH₄) | 0.605 | 0.605 | 0.877 | 0.877 | 0.792 |
| F2/P2 | ϕ (bar/bar) (abs) | 38.8 | 38.8 | 38.8 | 38.8 | 10.1 |
| F2/P2 | flow ratio (Nm³h⁻¹/Nm³h⁻¹) | 5.3 | 5.3 | 8.1 | 8.1 | 7.2 |
| F3 | mole ratio (H₂/CH₄) | 0.11 | 0.11 | 0.11 | 0.11 | 0.11 |
| F3 | mole % (H₂/H₂ + CH₄) | 0.10 | 0.10 | 0.10 | 0.10 | 0.10 |
| F3 | pressure bar (abs) | 50 | 50 | 50 | 50 | 50 |
| F3/R3 | flow ratio (Nm³h⁻¹/Nm³h⁻¹) | 1.518 | 1.518 | 1.194 | 1.194 | 1.194 |
| R3 | mole ratio (H₂/CH₄) | 0.01 | 0.01 | 0.01 | 0.01 | 0.01 |
| R3 | mole % (H₂/H₂ + CH₄) | 0.01 | 0.01 | 0.01 | 0.01 | 0.01 |
| R3 | pressure bar (abs) | 49.5 | 49.5 | 49.5 | 49.5 | 49.5 |
| P3 | mole ratio (H₂/CH₄) | 0.377 | 0.377 | 1.294 | 1.294 | 1.294 |
| P3 | mole % (H₂/H₂ + CH₄) | 0.274 | 0.274 | 0.564 | 0.564 | 0.564 |
| F3/P3 | ϕ (bar/bar) (abs) | 38.5 | 38.5 | 38.5 | 38.5 | 38.5 |
| F3/P3 | flow ratio (Nm³h⁻¹/Nm³h⁻¹) | 2.9 | 2.9 | 6.2 | 6.2 | 6.2 |

TABLE 6
Simulated results of examples 6 to 10.

| | | Example | | | | |
|---|---|---|---|---|---|---|
| All Stages | membrane selectivity (α) | 6 | 7 | 8 | 9 | 10 |
| Stream | units | 50 | 50 | 200 | 200 | 200 |
| F1 | mole ratio (H₂/CH₄) | 0.25 | 0.25 | 0.25 | 0.25 | 0.25 |
| F1 | mole % (H₂/H₂ + CH₄) | 0.20 | 0.20 | 0.20 | 0.20 | 0.20 |
| F1 | pressure bar (abs) | 51 | 51 | 51 | 51 | 51 |
| F1/R1 | flow ratio (Nm³h⁻¹/Nm³h⁻¹) | 1.0063 | 1.0063 | 1.0051 | 1.0052 | 1.0052 |
| R1 | mole ratio (H₂/CH₄) | 0.244 | 0.244 | 0.244 | 0.244 | 0.244 |
| R1 | mole % (H₂/H₂ + CH₄) | 0.196 | 0.196 | 0.196 | 0.196 | 0.196 |
| R1 | pressure bar (abs) | 50.5 | 50.5 | 50.5 | 50.5 | 50.5 |
| P1 | mole ratio (H₂/CH₄) | 4.89 | 4.89 | 43.19 | 25.95 | 25.95 |
| P1 | mole % (H₂/H₂ + CH₄) | 0.830 | 0.830 | 0.977 | 0.963 | 0.963 |
| F1/P1 | ϕ (bar/bar) (abs) | 6.8 | 6.8 | 39.2 | 10.2 | 10.2 |
| F1/P1 | flow ratio (Nm³h⁻¹/Nm³h⁻¹) | 158.5 | 158.5 | 195.3 | 191.7 | 191.7 |
| F2 | mole ratio (H₂/CH₄) | 0.244 | 0.244 | 0.244 | 0.244 | 0.244 |
| F2 | mole % (H₂/H₂ + CH₄) | 0.196 | 0.196 | 0.196 | 0.196 | 0.196 |
| F2 | pressure bar (abs) | 50.5 | 50.5 | 50.5 | 50.5 | 50.5 |
| F2/R2 | flow ratio (Nm³h⁻¹/Nm³h⁻¹) | 1.141 | 1.161 | 1.125 | 1.125 | 1.133 |
| R2 | mole ratio (H₂/CH₄) | 0.11 | 0.11 | 0.11 | 0.11 | 0.11 |
| R2 | mole % (H₂/H₂ + CH₄) | 0.10 | 0.10 | 0.10 | 0.10 | 0.10 |
| R2 | pressure bar (abs) | 50 | 50 | 50 | 50 | 50 |
| P2 | mole ratio (H₂/CH₄) | 7.1 | 3.8 | 27.7 | 27.7 | 11.1 |
| P2 | mole % (H₂/H₂ + CH₄) | 0.877 | 0.792 | 0.965 | 0.965 | 0.918 |
| F2/P2 | ϕ (bar/bar) (abs) | 38.8 | 10.1 | 38.8 | 38.8 | 10.1 |
| F2/P2 | flow ratio (Nm³h⁻¹/Nm³h⁻¹) | 8.1 | 7.2 | 9.0 | 9.0 | 8.5 |
| F3 | mole ratio (H₂/CH₄) | 0.11 | 0.11 | 0.11 | 0.11 | 0.11 |
| F3 | mole % (H₂/H₂ + CH₄) | 0.10 | 0.10 | 0.10 | 0.10 | 0.10 |
| F3 | pressure bar (abs) | 50 | 50 | 50 | 50 | 50 |
| F3/R3 | flow ratio (Nm³h⁻¹/Nm³h⁻¹) | 1.194 | 1.194 | 1.136 | 1.136 | 1.136 |
| R3 | mole ratio (H₂/CH₄) | 0.01 | 0.01 | 0.01 | 0.01 | 0.01 |
| R3 | mole % (H₂/H₂ + CH₄) | 0.01 | 0.01 | 0.01 | 0.01 | 0.01 |
| R3 | pressure bar (abs) | 49.5 | 49.5 | 49.5 | 49.5 | 49.5 |
| P3 | mole ratio (H₂/CH₄) | 1.294 | 1.294 | 3.187 | 3.187 | 3.187 |
| P3 | mole % (H₂/H₂ + CH₄) | 0.564 | 0.564 | 0.761 | 0.761 | 0.761 |
| F3/P3 | ϕ (bar/bar) (abs) | 38.5 | 38.5 | 38.5 | 38.5 | 38.5 |
| F3/P3 | flow ratio (Nm³h⁻¹/Nm³h⁻¹) | 6.2 | 6.2 | 8.3 | 8.3 | 8.3 |

TABLE 7
Simulated results of examples 11 to 15.

| All | | Example | | | | |
|---|---|---|---|---|---|---|
| Stages | membrane selectivity (α) | 11 | 12 | 13 | 14 | 15 |
| Stream | units | 200 | 200 | 200 | 2000 | 2000 |
| F1 | mole ratio (H₂/CH₄) | 0.25 | 0.25 | 0.25 | 0.25 | 0.25 |
| F1 | mole % (H₂/H₂ + CH₄) | 0.20 | 0.20 | 0.20 | 0.20 | 0.20 |
| F1 | pressure bar (abs) | 51 | 51 | 51 | 51 | 51 |
| F1/R1 | flow ratio (Nm³h⁻¹/Nm³h⁻¹) | 1.0054 | 1.0054 | 1.0059 | 1.0050 | 1.0050 |
| R1 | mole ratio (H₂/CH₄) | 0.244 | 0.244 | 0.244 | 0.244 | 0.244 |
| R1 | mole % (H₂/H₂ + CH₄) | 0.196 | 0.196 | 0.196 | 0.196 | 0.196 |
| R1 | pressure bar (abs) | 50.5 | 50.5 | 50.5 | 50.5 | 50.5 |
| P1 | mole ratio (H₂/CH₄) | 15.14 | 15.14 | 6.89 | 430.36 | 250.35 |
| P1 | mole % (H₂/H₂ + CH₄) | 0.938 | 0.938 | 0.873 | 0.998 | 0.996 |
| F1/P1 | ϕ (bar/bar) (abs) | 6.8 | 6.8 | 5.1 | 39.2 | 10.2 |
| F1/P1 | flow ratio (Nm³h⁻¹/Nm³h⁻¹) | 185.5 | 185.5 | 169.3 | 200.4 | 200.0 |
| F2 | mole ratio (H₂/CH₄) | 0.244 | 0.244 | 0.244 | 0.244 | 0.244 |
| F2 | mole % (H₂/H₂ + CH₄) | 0.196 | 0.196 | 0.196 | 0.196 | 0.196 |
| F2 | pressure bar (abs) | 50.5 | 50.5 | 50.5 | 50.5 | 50.5 |
| F2/R2 | flow ratio (Nm³h⁻¹/Nm³h⁻¹) | 1.125 | 1.133 | 1.125 | 1.120 | 1.120 |
| R2 | mole ratio (H₂/CH₄) | 0.11 | 0.11 | 0.11 | 0.11 | 0.11 |
| R2 | mole % (H₂/H₂ + CH₄) | 0.10 | 0.10 | 0.10 | 0.10 | 0.10 |
| R2 | pressure bar (abs) | 50 | 50 | 50 | 50 | 50 |
| P2 | mole ratio (H₂/CH₄) | 27.7 | 11.1 | 27.7 | 274.5 | 274.5 |
| P2 | mole % (H₂/H₂ + CH₄) | 0.965 | 0.918 | 0.965 | 0.996 | 0.996 |
| F2/P2 | ϕ (bar/bar) (abs) | 38.8 | 10.1 | 38.8 | 38.8 | 38.8 |
| F2/P2 | flow ratio (Nm³h⁻¹/Nm³h⁻¹) | 9.0 | 8.5 | 9.0 | 9.3 | 9.3 |
| F3 | mole ratio (H₂/CH₄) | 0.11 | 0.11 | 0.11 | 0.11 | 0.11 |
| F3 | mole % (H₂/H₂ + CH₄) | 0.10 | 0.10 | 0.10 | 0.10 | 0.10 |
| F3 | pressure bar (abs) | 50 | 50 | 50 | 50 | 50 |
| F3/R3 | flow ratio (Nm³h⁻¹/Nm³h⁻¹) | 1.136 | 1.136 | 1.136 | 1.114 | 1.114 |
| R3 | mole ratio (H₂/CH₄) | 0.01 | 0.01 | 0.01 | 0.01 | 0.01 |
| R3 | mole % (H₂/H₂ + CH₄) | 0.01 | 0.01 | 0.01 | 0.01 | 0.01 |
| R3 | pressure bar (abs) | 49.5 | 49.5 | 49.5 | 49.5 | 49.5 |
| P3 | mole ratio (H₂/CH₄) | 3.187 | 3.187 | 3.187 | 8.077 | 8.077 |
| P3 | mole % (H₂/H₂ + CH₄) | 0.761 | 0.761 | 0.761 | 0.890 | 0.890 |
| F3/P3 | ϕ (bar/bar) (abs) | 38.5 | 38.5 | 38.5 | 38.5 | 38.5 |
| F3/P3 | flow ratio (Nm³h⁻¹/Nm³h⁻¹) | 8.3 | 8.3 | 8.3 | 9.8 | 9.8 |

TABLE 8
Simulated results of examples 16 to 20.

| All | | Example | | | | |
|---|---|---|---|---|---|---|
| Stages | membrane selectivity (α) | 16 | 17 | 18 | 19 | 20 |
| Stream | units | 2000 | 2000 | 2000 | 2000 | 2000 |
| F1 | mole ratio (H₂/CH₄) | 0.25 | 0.25 | 0.25 | 0.25 | 0.25 |
| F1 | mole % (H₂/H₂ + CH₄) | 0.20 | 0.20 | 0.20 | 0.20 | 0.20 |
| F1 | pressure bar (abs) | 51 | 51 | 51 | 51 | 51 |
| F1/R1 | flow ratio (Nm³h⁻¹/Nm³h⁻¹) | 1.005 | 1.005 | 1.005 | 1.005 | 1.005 |
| R1 | mole ratio (H₂/CH₄) | 0.244 | 0.244 | 0.244 | 0.244 | 0.244 |
| R1 | mole % (H₂/H₂ + CH₄) | 0.196 | 0.196 | 0.196 | 0.196 | 0.196 |
| R1 | pressure bar (abs) | 50.5 | 50.5 | 50.5 | 50.5 | 50.5 |
| P1 | mole ratio (H₂/CH₄) | 250.3 | 129.9 | 129.9 | 129.9 | 24.2 |
| P1 | mole % (H₂/H₂ + CH₄) | 0.996 | 0.992 | 0.992 | 0.992 | 0.960 |
| F1/P1 | ϕ (bar/bar) (abs) | 10.2 | 6.8 | 6.8 | 6.8 | 5.1 |
| F1/P1 | flow ratio (Nm³h⁻¹/Nm³h⁻¹) | 200.0 | 199.1 | 199.1 | 199.1 | 191.1 |
| F2 | mole ratio (H₂/CH₄) | 0.244 | 0.244 | 0.244 | 0.244 | 0.244 |
| F2 | mole % (H₂/H₂ + CH₄) | 0.196 | 0.196 | 0.196 | 0.196 | 0.196 |
| F2 | pressure bar (abs) | 50.5 | 50.5 | 50.5 | 50.5 | 50.5 |
| F2/R2 | flow ratio (Nm³h⁻¹/Nm³h⁻¹) | 1.121 | 1.120 | 1.121 | 1.138 | 1.120 |
| R2 | mole ratio (H₂/CH₄) | 0.11 | 0.1 | 0.11 | 0.11 | 0.11 |
| R2 | mole % (H₂/H₂ + CH₄) | 0.10 | 0.10 | 0.10 | 0.10 | 0.10 |
| R2 | pressure bar (abs) | 50 | 50 | 50 | 50 | 50 |
| P2 | mole ratio (H₂/CH₄) | 75.7 | 274.5 | 75.7 | 8.1 | 274.5 |
| P2 | mole % (H₂/H₂ + CH₄) | 0.987 | 0.996 | 0.987 | 0.891 | 0.996 |
| F2/P2 | ϕ (bar/bar) (abs) | 10.1 | 38.8 | 10.1 | 6.7 | 38.8 |
| F2/P2 | flow ratio (Nm³h⁻¹/Nm³h⁻¹) | 9.2 | 9.3 | 9.2 | 8.2 | 9.3 |
| F3 | mole ratio (H₂/CH₄) | 0.11 | 0.11 | 0.11 | 0.11 | 0.11 |
| F3 | mole % (H₂/H₂ + CH₄) | 0.10 | 0.10 | 0.10 | 0.10 | 0.10 |
| F3 | pressure bar (abs) | 50 | 50 | 50 | 50 | 50 |
| F3/R3 | flow ratio (Nm³h⁻¹/Nm³h⁻¹) | 1.114 | 1.114 | 1.114 | 1.114 | 1.114 |
| R3 | mole ratio (H₂/CH₄) | 0.01 | 0.01 | 0.01 | 0.01 | 0.01 |
| R3 | mole % (H₂/H₂ + CH₄) | 0.01 | 0.01 | 0.01 | 0.01 | 0.01 |
| R3 | pressure bar (abs) | 49.5 | 49.5 | 49.5 | 49.5 | 49.5 |
| P3 | mole ratio (H₂/CH₄) | 8.077 | 8.077 | 8.077 | 8.077 | 8.077 |
| P3 | mole % (H₂/H₂ + CH₄) | 0.890 | 0.890 | 0.890 | 0.890 | 0.890 |
| F3/P3 | ϕ (bar/bar) (abs) | 38.5 | 38.5 | 38.5 | 38.5 | 38.5 |
| F3/P3 | flow ratio (Nm³h⁻¹/Nm³h⁻¹) | 9.8 | 9.8 | 9.8 | 9.8 | 9.8 |

### DESCRIPTION OF THE FIGURE

FIG. 1 Shown is a schematic of an apparatus according to preferred embodiments of the present invention. A feed stream F1 of a gas mixture comprising, preferably consisting of, H₂ and CH₄, is introduced into unit (I) comprising a membrane unit A. The feed stream F1 passes through the membrane unit A and is separated into permeate gas stream P1 and retentate gas stream R1. The hydrogen concentration present in P1 is greater than R1 and F1. R1 can be optionally divided into feed gas stream F2 and gas stream S1. The composition of feed gas F2 and optionally gas stream S1 is the same as retentate gas stream R1. Retentate gas stream R1 is passed as feed gas F2 into unit (II) comprising membrane unit B. The feed stream F2 passes through the membrane unit B and is separated into permeate gas stream P2 and retentate gas stream R2. The hydrogen concentration present in P2 is greater than R2 and F2. R1 can be optionally divided into feed gas stream F3 and gas stream S2. The composition of feed gas F3 and optionally gas stream S2 is the same as retentate gas stream R2. P2 can be further purified optionally for use as a reductant. Retentate gas stream R2 is passed as feed gas F3 into unit (III) comprising membrane unit C. The feed stream F3 passes through the membrane unit C and is separated into permeate gas stream P3 and retentate gas stream R3. The hydrogen concentration present in P3 is greater than R3 and F3. R3 has a hydrogen to methane mole ratio of 0.01 or less. P3 can optionally be further purified for use as a reductant or used as an energy source preferably for heating.

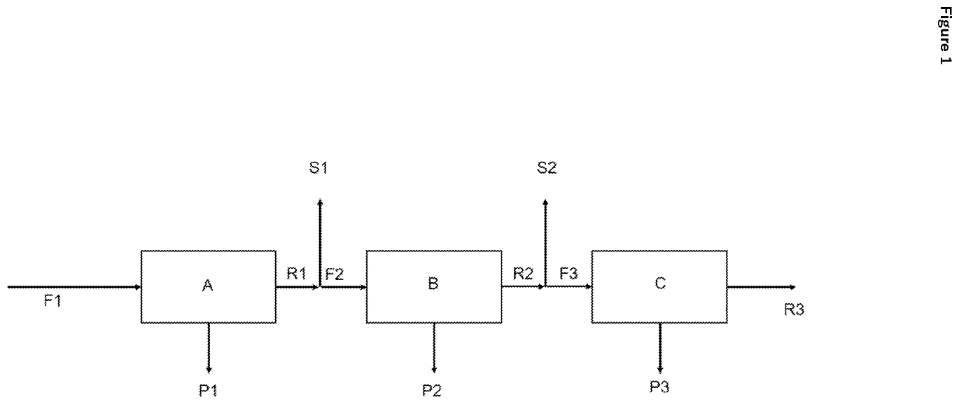

For instance when all streams are active in a three unit system as described above where membrane units A to C have a selectivity of 200; a simulation calculated with
F1 having a pressure of 51 bar (abs) and a H₂/CH₄ molar ratio of 0.25 was separated by membrane unit A of unit (I) into
   P1 having a pressure ratio ϕ (pressure F1/P1 at constant T) of 10.2, a flow ratio of (flow F1/P1) of 15.43, and a H₂/CH₄ molar ratio of 19 and;
   R1 having a pressure of 50.5 bar (abs), a flow ratio of (flow F1/R1) of 1.069, and a H₂/CH₄ molar ratio of 0.174, R1 was further divided into F2 and S1 having the same composition and pressure of R1 with a flow ratio of (flow R1/F2) of 1.38 and a flow ratio of (flow R1/S1) of 3.58;
F2 was further separated by membrane unit B of unit (II) into
   P2 having a pressure ratio ϕ (pressure F2/P2 at constant T) of 10.1, a flow ratio of (flow F2/P2) of 7.14, and a H₂/CH₄ molar ratio of 2.98 and;
   R2 having a pressure of 50 bar (abs), a flow ratio of (flow F2/R2) of 1.16, and a H₂/CH₄ molar ratio of 0.053, R2 was further divided into F3 and S2 having the same composition and pressure of R2 with a flow ratio of (flow R2/F3) of 3.04 and a flow ratio of (flow R2/S2) of 1.49;
F3 was further separated by membrane unit C of unit (III) into
   P3 having a pressure ratio ϕ (pressure F3/P3 at constant T) of 38.5, a flow ratio of (flow F3/P3) of 15.28, and a H₂/CH₄ molar ratio of 1.6 and
   R3 having a pressure of 49.5 bar (abs), a flow ratio of (flow F3/R3) of 1.07, and a H₂/CH₄ molar ratio of 0.01.

### CITED LITERATURE

Saltonstall, C. W., “Calculation of the membrane area required for gas separations”, Journal of Membrane Science, 1987, Volume 32, Issues 2-3, pages 185 to 193.
Deutscher Verein des Gas- und Wasserfaches e.V. (2019), “Anforderungen, Möglichkeiten und Grenzen der Abtrennung von Wasserstoff aus Wasser-stoff/Erdgasgemischen”
EP 2979743 A1

1.-21. (canceled)

22. A process for separating H₂ from a gas mixture comprising H₂ and CH₄, the process comprising
(i) a separation stage comprising
(i.1) passing a feed gas stream F1 comprising H₂ and CH₄ at a molar ratio n(H₂):n(CH₄)=x(F1), 0<x(F1)≤0.5, through a membrane unit A comprising at least one membrane, the at least one membrane having a H₂/CH₄ selectivity of at least 10, at a pressure ratio φ across said at least one membrane, calculated as (pressure of feed gas stream F1/pressure of permeate gas stream P1) at constant temperature, of greater than 1, obtaining
a permeate gas stream P1 comprising H₂ and CH₄ at a molar ratio n(H₂):n(CH₄)=x(P1); x(P1)>x(F1); and
a retentate gas stream R1 comprising H₂ and CH₄ at a molar ratio n(H₂):n(CH₄)=x(R1); x(R1)<x(F1);
(i.2) passing retentate gas stream R1 as a further feed gas stream F2 through a further separation stage, F2 having the same composition as R1;
(ii) a further separation stage comprising
(ii.1) passing F2 through a membrane unit B comprising at least one membrane, the at least one membrane having a H₂/CH₄ selectivity of at least 10, at a pressure ratio φ across said at least one membrane, calculated as (pressure of feed gas stream F2/pressure of permeate gas stream P2) at constant temperature, of greater than 1, obtaining
a permeate gas stream P2 comprising H₂ and CH₄ at a molar ratio n(H₂):n(CH₄)=x(P2) of at least 1.4; x(P2)>x(F2); and
a retentate gas stream R2 comprising H₂ and CH₄ at a molar ratio n(H₂):n(CH₄)=x(R2) of <0.17; x(R2)<x(F2);
(ii.2) optionally passing retentate gas stream R2 as a further feed gas stream F3 through a further separation stage (iii), F3 having the same composition as R2;
(iii) an optional further separation stage comprising
(iii.1) passing F3 through a further membrane unit C comprising at least one membrane, the at least one membrane having a H₂/CH₄ selectivity of at least 10, at a pressure ratio φ across said at least one membrane (calculated as the (pressure of feed gas stream F3/pressure of permeate gas stream P3) at constant temperature), of greater than 1, obtaining
a permeate gas stream P3 comprising H₂ and CH₄ at a molar ratio n(H₂):n(CH₄)=x(P3) of at least 0.39; x(P3)>x(F3); and
a retentate gas stream R3 comprising H₂ and CH₄ at a molar ratio n(H₂):n(CH₄)=x(R3) of ≤0.01.

23. The process of claim 22, wherein no vacuum apparatus or compressor is operated downstream of the membrane unit A in the obtainment of the permeate gas streams and/or retentate gas streams.

24. The process of claim 22, wherein the at least one membrane comprised in the respective membrane unit A, B and/or C has a H₂/CH₄ selectivity of at least 10.

25. The process of claim 22, wherein according to (i.1) the pressure ratio φ across the at least one membrane comprised in membrane unit A, calculated as (pressure of feed gas stream F1/pressure of permeate gas stream P1) at constant temperature, is of at least 4.

26. The process of claim 22, wherein the mole ratio x(F1) is in the range of from 0.05 to 0.5.

27. The process of claim 22, wherein feed gas stream F1 has pressure in the range of from 5 to 100 bar (abs); and
wherein the feed gas stream F1 has a temperature in the range of from −30° C. to 60° C.

28. The process of claim 22, wherein the mole ratio x(P1) is of at least 2.

29. The process of claim 22, wherein the permeate gas stream P1 has a pressure in the range of from >1 to 50 bar(abs).

30. The process of claim 22, wherein the mole ratio x(R1) is of at most 0.49, and wherein the retentate gas stream R1 has a pressure in the range of from 29.5 to 75.5 bar (abs).

31. The process of claim 22, wherein according to (i.1) the flow rate ratio of feed gas F1 to the retentate gas stream R1 calculated as (flow rate F1/flow rate R1) is in the range of from >1 to 2.

32. The process of claim 22, wherein according to (ii.1) the pressure ratio φ across the at least one membrane comprised in membrane unit B, calculated as (pressure of feed gas stream F2/pressure of permeate gas stream P2) at constant temperature, is of at least 4.

33. The process of claim 22, wherein the mole ratio x(P2) is of at least 1.5; and wherein the permeate gas stream P2 has a pressure in the range of from >1 to 15 bar(abs).

34. The process of claim 22, wherein the mole ratio x(R2) is of at most 0.15, and wherein the retentate gas stream R2 has a pressure in the range of from 29 to 75 bar (abs).

35. The process of claim 22, wherein according to (ii.1) the flow rate ratio of feed gas F2 to the retentate gas stream R2 calculated as (flow rate F2/flow rate R2) is in the range of from 1.05 to 2.

36. The process of claim 22, wherein according to (iii.1) the pressure ratio φ across the at least one membrane comprised in membrane unit C, calculated as (pressure of feed gas stream F3/pressure of permeate gas stream P3) at constant temperature is of at least 20.

37. The process of claim 22, wherein the mole ratio x(R3) is of at most 0.009, and wherein the retentate gas stream R3 has a pressure in the range of from 28.5 to 74.5 bar (abs).

38. The process of claim 22, wherein according to (iii.1) the flow rate ratio of feed gas F3 to the retentate gas stream R3 calculated as (flow rate F3/flow rate R3) is in the range of from 1.01 to 1.6.

39. An apparatus for separating H₂, from a gas mixture comprising H₂ and CH₄, the apparatus comprising
(I) a unit comprising
(I.a) a feeding means for passing a feed gas stream F1 comprising H₂ and CH₄ to a membrane unit A;
(I.b) the membrane unit A connected to the feeding means for passing a feed gas stream F1 according to (I.a), said membrane unit comprising at least one membrane, the at least one membrane having a H₂/CH₄ selectivity of at least 10;
(I.c) an exiting means connected to the membrane unit A, for removing a permeate gas stream P1 from the membrane unit A;
(Id) an exiting means connected to the membrane unit A for removing a retentate gas stream R1 from the membrane unit A;
(II) a unit comprising
(II.a) a feeding means, connected to the exiting means according to (Id), for passing the gas stream R1 as a feed gas F2 to a membrane unit B;
(II.b) the membrane unit B connected to the feeding means for passing a feed gas stream F2 according to (II.a), said membrane unit comprising at least one membrane, the at least one membrane having a H₂/CH₄ selectivity of at least 10;
(II.c) an exiting means connected to the membrane unit B for removing a permeate stream P2 from the membrane unit B;
(II.d) an exiting means connected to the membrane unit B for removing a retentate stream R2 from the membrane unit B;
(III) optionally a unit comprising
(III.a) a feeding means, connected to the exiting means according to (II.d), said feeding means for passing the gas stream F3 to a membrane unit C;
(III.b) the membrane unit C connected to the feeding means according to (III.a), said membrane unit comprising at least one membrane, the at least one membrane having a H₂/CH₄ selectivity of at least 10;
(III.c) an exiting means connected to the membrane unit C for removing a permeate stream P3 from the membrane unit C;
(III.d) an exiting means connected to the membrane unit C for removing a retentate stream R3 from the membrane unit C.

40. The apparatus of claim 39, wherein, in unit (I), there is no compressor upstream of the membrane unit A;
wherein no vacuum apparatus is disposed downstream of the membrane unit A; and
wherein in the unit (II), there is no compressor for compressing the gas exiting the unit (I), upstream of the membrane unit B.

41. A process for the production of ammonia, comprising
using a permeate gas stream P1 and/or P2, obtained according to a process according to claim 22, as a reductant.

42. A process selected from the group consisting of acetylene production, methanol production, olefin production, power generation and combinations of two or more thereof, the process comprising
using a retentate gas R2 and/or R3, obtained according to a process according to claim 22, as a hydrocarbon source.
